(19) United States
(12) Patent Application Publication
(10) Pub. No.: US 2024/0105921 A1
(43) Pub. Date: Mar. 28, 2024

(54) METHOD FOR PREPARING AN ELECTRODE MATERIAL AND ELECTROCHEMICAL USE THE SAME

(71) Applicant: City University of Hong Kong, Kowloon (HK)

(72) Inventors: Qi Liu, Kowloon (HK); Yang Ren, Kowloon (HK); Dong Luo, Kowloon (HK); He Zhu, Kowloon (HK); Zijia Yin, Kowloon (HK)

(21) Appl. No.: 18/362,242

(22) Filed: Jul. 31, 2023

Related U.S. Application Data
(60) Provisional application No. 63/377,386, filed on Sep. 28, 2022.

(51) Int. Cl. H01M 4/36; C01G 53/00; H01M 4/131; H01M 4/505; H01M 4/525; H01M 50/109

(52) U.S. Cl. CPC H01M 4/366; C01G 53/50; H01M 4/131; H01M 4/505; H01M 4/525; H01M 50/109; H01M 2004/028

(57) ABSTRACT

A method for preparing an electrode material includes: a) producing a microspherical precursor by way of co-precipitation; b) forming an intermediate product by calcining the precursor with a stoichiometric amount of sodium carbonate, lithium carbonate and a structural stabilizer; and c) performing an ion exchange process to the intermediate product under molten LiNO₃/LiCl to form a lumpy residue. An electrode for lithium-ion battery includes an electrode material having a general formula of Li[Li_{1/3}(TMₓAl_{y})]O₂, and lithium-ion battery comprising an electrode such as a cathode having the above electrode material are also addressed.

### TECHNICAL FIELD

The present invention relates to a method for preparing an electrode material for example particularly, but not exclusively, a cathodic material for a lithium-ion battery. Also pertaining to the present invention is an electrode comprising the electrode material and a lithium-ion battery comprising the electrode.

### BACKGROUND OF THE INVENTION

Lithium ion batteries (LIBs) have been playing an increasingly important role in powering modern society and mitigating climate change by utilizing renewable energy resources. Typically, in a LIB, the anode materials (e.g., graphite, silicon, etc.) offer much higher capacity and lower cost than the cathode materials (e.g., layered oxides, spinels, olivine, etc.). Thus, the cathode materials are generally considered a performance limiting factor in increasing the energy density of the batteries.

Among all cathode materials, the Li- and Mn-rich layered oxides (LMRs) stand out as one of the most promising candidates because they employ both cation and anion redox reactions that can produce significant energy density increases. However, several challenging issues, such as the irreversible oxygen release (low initial Coulombic efficiency), the electrolyte decomposition, and especially voltage decay, remain to be tackled prior to commercialization. For instance, the irreversible oxygen release and the electrolyte decomposition will release gas during electrochemical activation and ongoing cycling, which is a safety hazard for battery systems and will in turn worsen the electrochemical performance. In particular, the voltage decay of LMRs not only leads to a continuous decrease in energy density but also brings significant challenges for battery management systems, further hindering their practical application.

For decades, although there are reports, such as by way of surface coating, doping, defect/interfacial engineering, phase and morphology control, etc., attempted to tackle the voltage decay issue, it is believed that the voltage decay of LMRs, still remains as an unsolved problem for these materials.

Thus, there remains a strong need in providing a new or otherwise improved cathode material such as a cathode material including LMRs that may arrange to stabilize the honeycomb structure in the LMRs for eliminating or at least mitigating such shortcomings.

### SUMMARY OF THE INVENTION

In a first aspect of the present invention, there is provided a method for preparing an electrode material comprising the steps of: a) producing a microspherical precursor by way of co-precipitation; b) forming an intermediate product by calcining the precursor with a stoichiometric amount of sodium carbonate, lithium carbonate and a structural stabilizer; and c) performing an ion exchange process to the intermediate product under molten LiNO₃/LiCl to form a lumpy residue.

Optionally, step a) comprises the steps of: providing a first aqueous solution comprising at least two transition metal sulfates selected from sulfates of nickel, iron, manganese, titanium, zirconium, vanadium, or chromium; providing a second aqueous solution comprising one or more of a precipitating agent selected from a group consisting of ammonium hydroxide, sodium carbonate, sodium bicarbonate, sodium hydroxide, and potassium hydroxide; and mixing the first and the second aqueous solutions to form a first reaction mixture for co-precipitation.

In an optional embodiment, the first aqueous solution comprises NiSO₄·6H₂O and MnSO₄·H₂O with a molar ratio of Ni:Mn≈1:3.

In an optional embodiment, the second aqueous solution comprises NH₃·H₂O and Na₂CO₃.

Optionally, the first reaction mixture has a pH of about 8 to about 9.

It is optional that the structural stabilizer comprises Al₂O₃.

In an optional embodiment, the sodium carbonate, lithium carbonate, and Al₂O₃ have a molar ratio of about 12:4:1 with respect to Na:Li:Al and are mixed with the precursor to form a second reaction mixture.

Optionally, the calcining process is performed at about 780° C. for about 8 hours to about 10 hours.

It is optional that the ion exchange process is performed at about 300° C. for about 4 hours.

In an optional embodiment, the first and second aqueous solutions are pumped simultaneously into a continuously stirred tank reactor under N₂ atmosphere at a temperature of about 50° C. It is optional that the first aqueous solution has a concentration in a range of about 1.5-3 mol/L

Optionally, concentration ratio between the transition metal sulfates and the precipitating agent is in a range of about 1-2.

In a second aspect of the present invention, there is provided an electrode for lithium-ion battery comprising an electrode material having a general formula of Li[Li_{1/3}(TMₓAl_{y})]O₂, wherein TM is a transition metal selected from one or more of nickel, iron, manganese, titanium, zirconium, vanadium, chromium, and x+y=⅔; and the electrode material comprises a dual phase layered structure.

In an optional embodiment, the dual phase layered structure comprises a heterogeneous structure of LiTMO₂ domain and Li₂MnO₃ domain, with TM being a transition metal selected from one or more of nickel, iron, manganese, titanium, zirconium, vanadium, chromium.

Optionally, both the LiTMO₂ domain and Li₂MnO₃ domain are arranged in a form of an O2-type stacking lattice. It is optional that the LiTMO₂ domain is arranged as a hexagonal lattice. Optionally, the hexagonal lattice has a space group of P6₃mc.

Optionally, the Li₂MnO₃ domain is arranged as an orthorhombic lattice. It is optional that the orthorhombic lattice has a space group of Cmc2₁.

In an optional embodiment, the Li₂MnO₃ domain has a honeycomb LiMn₆ ordering structure. Optionally, at least a portion of TM partially occupies the interlayer Li site of the Li₂MnO₃ domain. It is optional that every three Li sites is substituted by one TM.

In an embodiment of the invention, each of the TM bonds to three oxygen atoms from the LiO₆ octahedron of the honeycomb structure, thereby stabilizing the honeycomb structure. Optionally, each of the TM is located at a position just above or below the Li atom of the LiO₆ octahedron.

In an optional embodiment, Al acts as a dopant which further stabilizes the honeycomb structure by forming bonding with oxygen atom within the honeycomb structure.

In an embodiment of the invention, the electrode material has a spherical morphology agglomerated compactly with primary grains. Optionally, the electrode material comprises Li_{1.1}(Ni_{0.21}Mn_{0.65}Al_{0.04})O₂.

In an embodiment of the invention, the electrode comprises a cathode.

In a third aspect of the present invention, there is provided a lithium-ion battery comprising an electrode in accordance with the second aspect, wherein the electrode is a cathode.

In an optional embodiment, the lithium-ion battery comprises a half coin cell, wherein the cathode comprises an electrode material having Li_{1.1}(Ni_{0.21}Mn_{0.65}Al_{0.04})O₂. Optionally, the cathode is electrically connected to an anode comprises lithium metal.

In an optional embodiment, the lithium-ion battery comprises a full coin cell wherein the cathode comprises an electrode material having Li_{1.1}(Ni_{0.21}Mn_{0.65}Al_{0.04})O₂.

Optionally, the cathode is electrically connected to an anode comprises activated graphite.

It is optional that the average voltage of the battery remains substantially unchanged for at least 50 charge-discharge cycles at C/3. In an embodiment of the invention, the average voltage decays constantly by about 0.02 mV per cycle.

### BRIEF DESCRIPTION OF DRAWINGS

The invention will now be more particularly described, by way of example only, with reference to the accompanying drawings, in which:

FIG. 1A is a schematic diagram illustrating the structure of LiTMO₂ domain and Li₂MnO₃ domain in accordance with an embodiment of the invention;

FIG. 1B is a schematic diagram illustrating the honeycomb local structure pinned with TM_{Li} ion in accordance with an embodiment of the invention;

FIG. 1C is a schematic diagram illustrating a sectional view of the structure with TM_{U} atoms located just next to the honeycomb;

FIG. 2 is a schematic diagram illustrating change of layer stacking sequence from P2 to O2 (or O4) during ion-exchange process. The areas 202 and 204 are represent the local structure around Na⁺ in P2 and Li⁺ in O2 lattice, respectively;

FIG. 3 is a schematic diagram illustrating the atomic arrangement of the O2-type layered LiTMO₂ and Li₂MnO₃ phases along the [110] zone axis;

FIG. 4A shows the powder XRD data of the P2-type layered NaₓLi_{y}Mn_{z}Ni_{1-y-z}O₂ precursor along with the standard P2-type XRD pattern. The inset shows weak reflections of the Li/Mn ordering;

FIG. 4B is a STEM-HAADF image of the P2-type layered NaₓLi_{y}Mn_{z}Ni_{1-y-z}O₂ precursor along [110] zone axis;

FIG. 4C shows an enlarged STEM-HAADF image of FIG. 4B, with a dashed line indicating the position upon in-line profile characterization;

FIG. 4D shows a HADDF in-line profile acquired along the dashed line in FIG. 4C;

FIG. 5A shows a SEM image of the final CH-LMR product;

FIG. 5B shows a SEM image of the P2 mesophase precursor;

FIG. 6 shows the experimental XRD data along with calculated XRD patterns of the O2-type layered LiTMO₂ and Li₂MnO₃ phases;

FIG. 7A shows a SEM image of CH-LMR consisting both layered LiTMO₂ and Li₂MnO₃ phases;

FIG. 7B shows a STEM-HAADF image of dumbbell-like superstructure in the Li₂MnO₃ phase viewed along the [110] zone axis, and an enlarged image emphasizing the atomic arrangement as well as showing dashed lines 702 and 704 which indicate the positions upon in-line profile characterization;

FIG. 8 shows the HADDF in-line profile acquired along the dashed line 702 in FIG. 7B;

FIG. 9 shows the STEM image of Li₂MnO₃ area emphasizing the stacks of O2 and O4;

FIG. 10A is a schematic diagram illustrating the O2-type Li₂MnO₃ phase of CH-LMR viewed along [010] zone axis;

FIG. 10B is a schematic diagram illustrating the O2-type Li₂MnO₃ phase of CH-LMR viewed along [100] zone axis;

FIG. 11A shows the experimental SAED pattern collected from the selected area in HAADF image;

FIG. 11B shows the simulated SAED patterns calculated from the [110] zone axis of the O2 and O4 stacks;

FIG. 12 shows the HADDF in-line profile acquired along the dashed line 704 in FIG. 7B;

FIG. 13 is a schematic diagram illustrating the interwoven mixture of [110]-axial O2-Li₂MnO₃ and [121]-axial cubic Fm-3 m structure;

FIG. 14A shows a STEM image of Li-rich material viewed along [110] zone axis;

FIG. 14B is a schematic diagram illustrating the crystal structure of Li-rich material of FIG. 14A;

FIG. 15A shows the STEM image of the CH-LMR cathode after subjecting to two charge-discharge cycles;

FIG. 15B is an enlarged STEM image of FIG. 15A;

FIG. 16A shows the STEM image taken on the CH-LMR charged at 4.7 V for 2 cycles. It is noticed that the partial TM_{Li} ions are still clearly observed at high voltage (4.7 V);

FIG. 16B shows the STEM image taken on the CH-LMR of FIG. 16A after being charged at 4.7 V for 50 cycles. It is noticed that the partial TM_{L}u ions are still clearly observed, suggesting the structure of the CH-LMR remains intact upon the whole cycling processes;

FIG. 17 shows the comparison of the XRD patterns collected from the pristine CH-LMR cathode and the cathode after running 50 cycles;

FIG. 18A is a schematic diagram illustrating three symmetrically distinct Li sites occupied by Ni in O2-MnO₃ (fully delithiated), denoted as Li1, Li2, and Li3, respectively;

FIG. 18B shows the relative energetics of Mn₄NiO₁₂ when Li1, Li2, and Li3 sites are occupied by Ni, respectively, with the corresponding migration barrier calculated using the nudged elastic band (NEB) method;

FIG. 18C shows the oxygen stability as a function of the number (x) of remaining Li atoms in O2-LiₓMn₄(Ni)O₁₂ with Ni on the Li3 site, Ni on the Li2 site, and without Ni, respectively;

FIG. 19A shows the statistical analysis of O—O pair distance and the corresponding average Bader charge in O2-Mn₄O₁₂;

FIG. 19B shows the statistical analysis of O—O pair distance and the corresponding average Bader charge in O2-Mn₄NiO₁₂ with Ni on the Li3 site;

FIG. 19C shows the statistical analysis of O—O pair distance and the corresponding average Bader charge in O2-Mn₄NiO₁₂ with Ni on the Li2 site;

FIG. 20A is a schematic diagram illustrating the setup for in situ focus-beam synchrotron measurement;

FIG. 20B is a photograph showing the experimental setup for in situ focus-beam synchrotron measurement as illustrated in FIG. 20A;

FIG. 21A shows the contour plots with voltage profile of the in situ XRD patterns;

FIG. 21B shows the stacked peak profiles of the in situ XRD patterns in FIG. 21A;

FIG. 21C shows the evolution of lattice parameters extracted from the in situ XRD patterns;

FIG. 22 shows the gas release measured via the in situ DEMS experiments;

FIG. 23A shows the charge-discharge curves at ˜0.1 C (20 mA/g) during the first three formation cycles in half-cells comprising the CH-LMR cathode;

FIG. 23B shows the electrochemical differential capacity (dQ/dV) plots in half-cells corresponding to FIG. 23A;

FIG. 24A shows the rate performance in half cells;

FIG. 24B shows the voltage and capacity stability at C/3 in half-cells;

FIG. 25A is an alternative representation of 3^{rd} charge-discharge curve in FIG. 23A;

FIG. 25B shows the 3^{rd} charge-discharge curve of commercial NCM622 cathode;

FIG. 25C shows the Coulombic efficiency of the CH-LMR and commercial NCM622 cathodes under the cut-off voltage of 4.7 V;

FIG. 25D shows the cumulative irreversible capacity loss of the CH-LMR and commercial NCM622 cathodes under the cut-off voltage of 4.7 V;

FIG. 26 is a table summarizing the voltage-decay rate of CH-LMR and reported Li-rich oxides;

FIG. 27 shows the normalized discharge curves of the CH-LMR sample at C/3;

FIG. 28A shows the normalized voltage-capacity profiles of the CH-LMR cathode in full-cells with a graphite anode at C/3 after three formation cycles;

FIG. 28B shows the voltage and capacity stability at C/3 in full-cells;

FIG. 29A shows the capacity performance of CH-LMR cathode without doped with Al at 1C; and

FIG. 29B shows the voltage performance of CH-LMR cathode without doped with Al at 1C.

### DETAILED DESCRIPTION OF OPTIONAL EMBODIMENT

As used herein, the forms “a”, “an”, and “the” are intended to include the singular and plural forms unless the context clearly indicates otherwise.

The words “example” or “exemplary” used in this invention are intended to serve as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion.

It is believed that the root cause of the voltage decay/fading is related to the instability of the honeycomb structure in Li₂MnO₃ at high voltage. In particular, at high-voltage conditions, the oxygen atoms in the honeycomb structure are destabilized through O—O dimers, leading to irreversible oxygen release. In addition, the generated oxygen vacancies will weaken the Mn—O bonding, promoting Mn migration to Li layers that terminates with irreversible structure degradation. In addition, the LMR may suffer from severe lattice strain accumulation induced by two different nanoscale domains electrochemically activated at different voltages, which triggers destabilization of Li₂MnO₃ and oxygen release as well. All these processes are closely connected and persistently occur with prolonged cycling, eventually leading to a lower operating voltage and a severe voltage drop in the LMR cathodes.

Without intending to be limited by theory, the inventors have, through their own research, trials, and experiments, devised a method for preparing a LMR without or substantially without voltage decay/fading upon high voltage cycling. The method particularly employs an ion exchange process which causes position configuration of the transition metal (TM) ions within the honeycomb structure upon the LMR preparation. It is found that, the as-prepared LMR may have the TM ions occupying the interlayer Li sites of Li₂MnO₃, and with an O2-stacked atomic arrangement, the TM ions are located just above or below the Li ions in the honeycomb structure, serving as a “cap” to pin the oxygen ions around the honeycomb Li. As demonstrated in the example embodiments, the capped-honeycomb structure stabilizes the honeycomb structure and suppresses oxygen release, cation migration and structure degradation, and therefore the LMR material of the present invention exhibits no or insignificant voltage decay upon cycling. In addition, the LMR material of the present invention does not require any cobalt element upon preparation (i.e., Co-free), which may contribute to cost-saving as well as cobalt element sustainability.

According to the invention, there is provided a method for preparing an electrode material, particularly a cathodic material of LMR without or substantially without voltage decay/fading. The method may comprise the steps of: a) producing a microspherical precursor by way of co-precipitation; b) forming an intermediate product by calcining the precursor with a stoichiometric amount of sodium carbonate, lithium carbonate and a structural stabilizer; and c) performing an ion exchange process to the intermediate product under molten LiNO₃/LiCl to form a lumpy residue.

Step a), in particular, may commence with providing a first aqueous solution comprising at least two transition metal sulfates.

In an embodiment, the transition metal sulfates may be selected from at least two of sulfates of nickel, iron, manganese, titanium, zirconium, vanadium, or chromium.

In a particular embodiment, the first aqueous solution may comprise NiSO₄·6H₂O and MnSO₄·H₂O with a molar ratio of, for example, Ni:Mn≈1:3. The first aqueous solution may have a concentration in a range of about 1.5 to about 3 mol/L. In an example embodiment, the first aqueous solution comprising NiSO₄·6H₂O and MnSO₄·H₂O may have 2 mol/L of NiSO₄·6H₂O and MnSO₄·H₂O, respectively.

Then, step a) may proceed to providing a second aqueous solution comprising one or more of a precipitating agent. The precipitating agent are preferably alkali salt such as those selected from a group consisting of ammonium hydroxide, sodium carbonate, sodium bicarbonate, sodium hydroxide, and potassium hydroxide. In a particular embodiment, the second aqueous solution may comprise NH₃·H₂O and Na₂CO₃ as the precipitating agents.

After the preparation of the first and the second aqueous solutions, step a) may further proceed to mixing the first and the second aqueous solutions to form a first reaction mixture for co-precipitation. The first reaction mixture preferably has a pH of about 8 to about 9. In an example embodiment, the first reaction mixture may be formed by introducing the first and the second aqueous solutions into a reactor, and stirring at particular reaction temperature under an inert atmosphere. For example, the first and second aqueous solutions may be pumped simultaneously into a continuously stirred tank reactor under N₂ atmosphere at a temperature of about 50° C. to form the first reaction mixture. The concentration ratio between the transition metal sulfates and the precipitating agent(s) in the first reaction mixture is preferably in a range of about 1-2. As such, it is appreciated that the pH of the first reaction mixture may be maintained to be alkaline such as at a pH of about 8 to about 9 as mentioned, particularly at a pH of about 8.4.

It is also appreciated that the step sequence of preparing the first aqueous solution and the second aqueous solution may be of any order. That said, a skilled person may prepare the first aqueous solution first, followed by the second aqueous solution or vice versa, or the skilled person may prepare the first and the second aqueous solutions at the same time.

Optionally or additionally, after co-precipitation, the raw/pristine/crude precursor may be isolated from the first reaction mixture, such as by way of filtering and/or washing with any suitable solvents such as water, followed by drying in vacuum at an elevated temperature such as about 90° C. to obtain the microspherical precursor as, for example, powders.

Step b) of the presently disclosed method involving a calcination process of the precursor with a stoichiometric amount of sodium carbonate, lithium carbonate and a structural stabilizer to form an intermediate product. The structural stabilizer preferably comprises an aluminum compound, such as Al₂O₃ and the like. In an embodiment, the sodium carbonate, lithium carbonate, and Al₂O₃ may have a molar ratio of about 12:4:1 with respect to Na:Li:Al and are mixed with the precursor (as obtained in step a)) to form a second reaction mixture. The second reaction mixture may then be subjected to calcination in air at a temperature of about 780° C. for about 8 h to about 10 h, followed by quenching to room temperature to obtain the intermediate product, particularly a black intermediate product of P2-Na_{0.6}Li_{0.2}Mn₃ₓNiₓO₂ (e.g. Na_{0.6}Li_{0.2}Ni_{0.2}Mn_{0.6}O₂) with Al-doping, where P2 indicates that the black intermediate product has a P2-type stacking lattice.

After obtaining the intermediate product in step b), the method may finally proceed to step c) which involves an ion exchange process that would cause the P2-type intermediate product to transform into an O2-type electrode material, particularly O2-type LMR material. It is appreciated that with the above intermediate product, an excess amount of transition metal ions (e.g. by about 13% stoichiometric amount) are incorporated into the intermediate product, and therefore it is expected that any excess TM ions with respect to the (P2-type) intermediate product would be thermodynamically disfavored from occupying the Na sites due to the unaccommodating prismatic coordination. As such, it is believed that during the subsequent ion exchange process (i.e. step c)), the alkali coordination between layers transforms from prism (P2) to octahedron (O2). The latter is suitable for accommodating TM ions and therefore facilitates TM migration to the alkali octahedra, occupying the alkali sites, competing with guest Li⁺ and finally reaching an unexpected O2 framework with TMs partially occupying the Li sites as disclosed in the later part of the present disclosure.

Turning back to the method, in an example embodiment, the intermediate product (as obtained in step b)) may be mixed with molten LiNO₃/LiCl and subjected to ion exchange process at about 300° C. for about 4 h to obtain a lumpy residue. Optionally or additionally, the lumpy residue may be washed, filtered, and dried at an elevated temperature such as about 180° C. for at least 8 h to obtain the electrode material.

As a specific embodiment, the electrode material as obtained from the above method may have a chemical formula of Li_{1.1}(Ni_{0.21}Mn_{0.65}Al_{0.04})O₂.

Another aspect of the invention is related to an electrode for lithium-ion battery. The electrode may be, in particular, a cathode, which comprises an electrode material having a general formula of Li[Li_{1/3}(TMₓAl_{y})]O₂, wherein TM is a transition metal selected from one or more of nickel, iron, manganese, titanium, zirconium, vanadium, chromium, and x+y=⅔. The electrode material may have a spherical morphology agglomerated compactly with primary grains. In a particular embodiment, the electrode material may comprise Li_{1.1}(Ni_{0.21}Mn_{0.65}Al_{0.04})O₂.

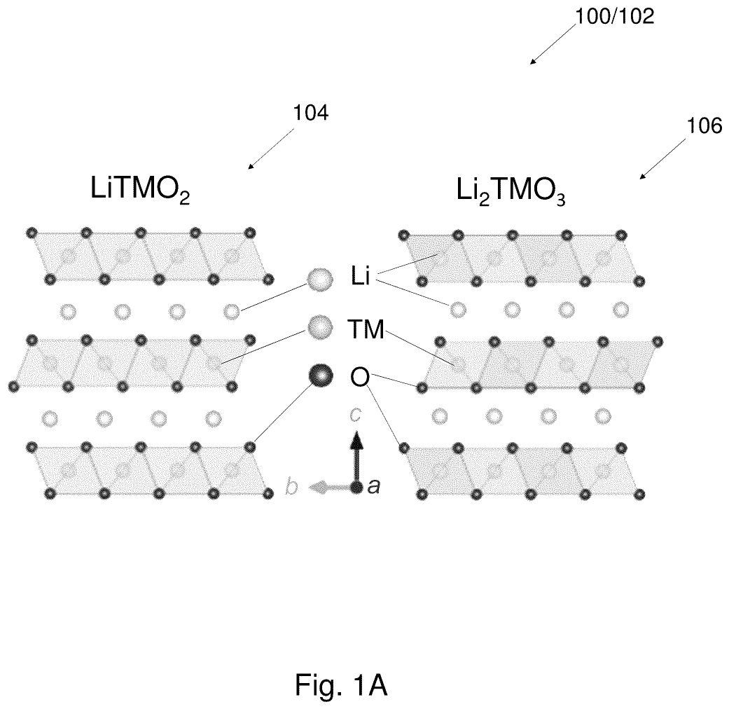

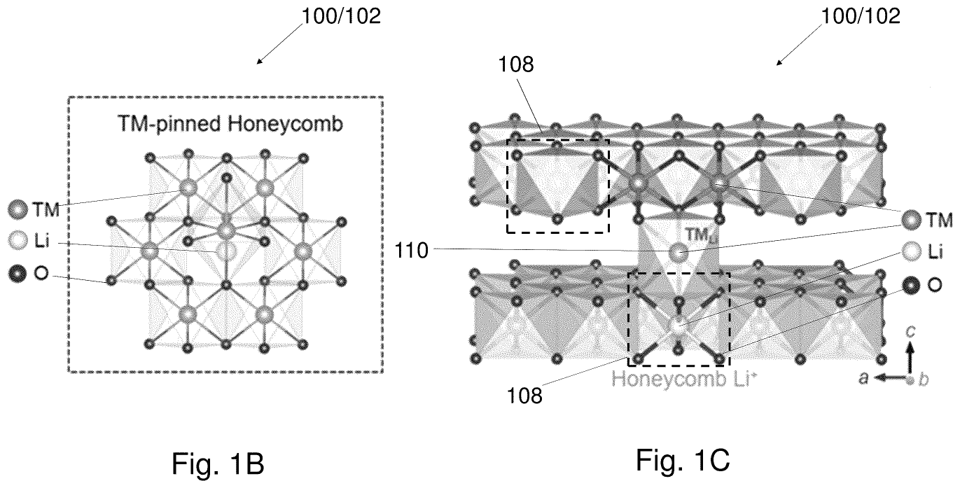

Preferably, the electrode material may comprise a dual phase layered structure. Referring to FIG. 1, there is provided an exemplary embodiment of an electrode material 100 having a dual phase layered structure 102. As shown, the dual phase layered structure comprises a LiTMO₂ domain/lattice 104 and a Li₂MnO₃ domain/lattice 106 that are arranged to form a heterogeneous structure thereof, with TM being a transition metal selected from one or more of nickel, iron, manganese, titanium, zirconium, vanadium, chromium, particularly selected from nickel and/or manganese. In particular, the LiTMO₂ domain/lattice 104 may be three-dimensionally incorporated into the Li₂MnO₃ domain/lattice 106 without obvious interphase boundaries such that these two phases are randomly mixed and share the coherent lattice structure. Preferably, both the LiTMO₂ domain and Li₂MnO₃ domain are arranged in a form of an O2-type stacking lattice. Within the O2-type stacking lattice, it is preferred that the LiTMO₂ domain 104 is arranged as a hexagonal lattice, in particular, a hexagonal lattice having a space group of P6₃mc. It is also preferred that the Li₂MnO₃ domain 106 is arranged as an orthorhombic lattice, in particular, an orthorhombic lattice having a space group of Cmc2₁. It is appreciated that with the above structural configuration, the Li₂MnO₃ domain would have a honeycomb LiMn₆ ordering structure when viewed along the [001] direction, such as the one as shown in FIG. 1B, and in the middle of the honeycomb, Li ions are bonded to adjacent O atoms to form a LiO₆ octahedron 108 as shown in FIG. 1C, enlisting either O²⁻/O⁻ or O²⁻/O₂ redox couple when subjected to high voltage cycling.

In particular, at least a portion of TM may partially occupy the interlayer Li site of the Li₂MnO₃ domain. For example, every three Li sites may be substituted by one TM and each of the TM bonds to three oxygen atoms from the LiO₆ octahedron 108 of the honeycomb structure, and may be located at a position just above or below the Li atom of the LiO₆ octahedron. With reference to FIG. 1C, in an embodiment, the interlayer Li site of the Li₂MnO₃ domain is partially occupied by the TM_{Li} 110. The TM_{Li} 100 substitutes the interlayer Li site by bonding to three oxygen atoms from the LiO₆ octahedron 108, forming a TM_{Li}O₆ octahedron which share the same face as the LiO₆ octahedron. That said, the LiO₆ octahedron is stabilized (“pinned”) by the TM_{Li} 110, thus stabilizing the honeycomb structure. Advantageously, it is believed that with the TM_{Li} occupancy, it would 1) at least minimize irreversible cation migration, in particular, at high voltage (such as at about 4.7 V) operation conditions; and 2) stabilizing the unstable honeycomb O²⁻ by localizing the O₂ₚ lone-pair state, thereby increasing the formation energy of oxygen vacancy and stabilizing oxygen. Optionally or additionally, it is believed that Al of the electrode material 100 may act as a dopant which further stabilizes the honeycomb structure by forming bonding with oxygen atom within the honeycomb structure. As such, it is believed that the electrode such as a cathode which includes the electrode material 100 would promote minimized voltage decay and enhanced cycling stability of the LIBs. Detailed electrochemical performance of the electrode 100 will be disclosed in the later part of the present disclosure.

Further pertaining to the present invention is a lithium-ion battery comprising an electrode, particularly a cathode as described herein. In an embodiment, the battery may comprise a half coin cell. The half coin cell may comprise a cathode including the electrode material of Li_{1.1}(Ni_{0.21}Mn_{0.65}Al_{0.04})O₂, an anode of lithium, and an electrolyte such as ethylene carbonate/ethyl methyl carbonate (3:7 by weight) with LiPF₆ (e.g., 1.2 mol L⁻¹) as the supporting electrolyte.

In another embodiment, the battery may be a full coin cell. The full coin cell may have a similar configuration as the half coin cell as mentioned above, except that the anode may comprise an activated graphite instead of the lithium metal. That said, the full coin cell may comprise a cathode including the electrode material of Li_{1.1}(Ni_{0.21}Mn_{0.65}Al_{0.04})O₂, an anode of activated graphite, and an electrolyte such as ethylene carbonate/ethyl methyl carbonate (3:7 by weight) with LiPF₆ (e.g., 1.2 mol L⁻¹) as the supporting electrolyte.

As described herein, it is believed that the electrode material of the present invention could promote minimized voltage decay and enhanced cycling stability of the LIBs. In an example embodiment, it is found that the average voltage of the lithium-ion battery remains substantially unchanged for at least 50 charge-discharge cycles at C/3. In particular, the average voltage may decay constantly by about 0.02 mV per cycle. Unexpectedly, it is found that such an insignificant voltage decay is independent of whether the battery has taken the form of a half coin cell or a full coin cell, supporting that the minimized voltage decay origins from the electrode material of the present invention.

Hereinafter, the present invention is described more specifically by way of examples, but the present invention is not limited thereto.

### EXAMPLES

### Characterization

The atomic ratio of the synthesized sample were measured by ICP-MS (Agilent 5100 ICP-OES). The crystal structure of the samples was investigated by a Rigaku SmartLab IV X-ray diffractometer equipped with a Cu target (λ=0.154 nm). The morphologies of CH-LMR powder were characterized using a JSM-7800F field emission scanning electron microscope (FE-SEM) operated at an acceleration voltage of 20 kV. High-resolution TEM and HAADF images were conducted on a JEM-ARM200F STEM fitted with a double-aberration corrector for both probe-forming and imaging lenses; the electron microscope was operated at 200 kV. The HAADF images were taken by an atomic-resolution analytical microscope (JEM-ARM 200F) operating at 200 kV. Samples for STEM-HAADF were prepared by dropping dilute toluene dispersion of nanocrystals onto a carbon-coated copper grid and evaporated at ambient temperature.

### Electrode Preparation and Electrochemical Measurements

The electrodes were prepared by spreading a slurry composed of 90% active materials, 5% poly(vinylidene difluoride) (PVDF) and 5% carbon black onto an aluminum foil and then dried at 75° C. in a vacuum for 24 h. The mass loading of the electrodes was kept at ˜3.7 mg cm⁻². Finally, the 2032-type coin cells were assembled in an argon-filled glovebox (H₂O and O2 of <1 ppm).

In the assembled process, the as-prepared electrode was used as the cathode, lithium metal was served as the anode, and the solution of 1.2 mol L⁻¹ LiPF₆ in ethylene carbonate/ethyl methyl carbonate ( 3/7 by weight) was employed as the electrolyte, forming a half-cell. Galvanostatic cycling tests of the home-made coin cells were conducted using a MACCOR battery cycler at room temperature. The initial formation cycle of the cells was carried out from 2.0 V to 4.8 V vs Li/Li⁺ at 0.1 C (20 mA g⁻¹). After that, the cells were tested at C/3 between 2.0 and 4.7 V.

The full-cells were also assembled in an argon-filled glovebox (H₂O and O2 of <1 ppm), used the activated graphite as the anode with the N/P ratio of 1.05. The activation process of graphite was executed in a half-cell at 0.1 C between 0.01 and 3.0 V to pre-form the SEI film which is to reduce the consumption of active Li ions, since SEI film is composed of various lithium-containing compounds and its formation in full-cells must consume active Li ions from the cathodes. The assembled process of the full-cells is almost the same as that of the half-cells, and the only difference is that the lithium metal is replaced with the activated graphite. The full-cells were tested under ⅓ C between 1.8 and 4.6 V after formation two cycles under 0.1 C and one cycle under 0.33 C.

### In situ Synchrotron Focus-Beam Diffraction Measurements

The in situ focus-beam synchrotron XRD characterizations were performed using the 11-ID-C beamline (λ=0.1173 Å) at Advanced Photon Source (APS), ANL, with a focused beam size of 2.5×300 μm (vertical×horizontal). The cell body adopted a RATIX-like design, allowing X-ray transmission in a plane parallel to the electrode stack. The prepared “CH-LMR cathode-separator-lithium anode” was fixed in the center of a quartz tube with the 4 mm inner diameter, and stainless-steel cylinders were employed on both sides to give the constant pressure and provide electrical contact. The in situ cells were cycled at a constant current of ⅓ C between 2.0 and 4.8 V vs. Li⁺/Li, and the in situ two-dimensional (2D) diffraction patterns were recorded every 1.5 minutes. Fit2D software was applied to calibrate the collected 2D diffraction patterns with the standard CeO₂ sample, and also to integrate the XRD patterns into one-dimensional profiles. Fullprof software was used to refine the in situ XRD patterns.

### In situ Gas Evolution Measurements

The in situ Differential Electrochemical Mass Spectrometer measurement (DEMS) was carried out to obtain the evolution of the gases (such as O₂, CO₂ etc.) generated during the initial charge-discharge process. The measured electrode consisted of 80 wt. % target materials, 10 wt. % carbon black and 10 wt. % PVDF (Solef 5130). It was coated on the Al foil and cut into 14 mm diameter discs with a loading density of about 5 mg cm⁻² for the target materials. The measured electrodes, lithium metal anodes and microporous polypropylene membrane separators (Celgard 2500) were assembled into an in situ commercial Swagelok type cell in an Ar-filled glovebox. After that, the measuring cell was connected to the mass spectrometer (QAS 100) and continuously purged with gaseous Ar (3.6 mL min⁻¹, purity 99.999%). After an initial 6-hour rest at open-circuit voltage, it was subjected to charge/discharge measurements in the voltage window of 2.0˜4.8 V on a typical Neware battery test system (CT-4008T-5V 50 mA-164).

### First-Principles Calculations

All simulations were conducted by means of the Vienna ab initio simulation package (VASP), which employs the projector augmented-wave (PAW) method in conjunction with the Perdew-Burke-Ernzerhof (PBE) version of the spin-polarized generalized gradient approximation (GGA) for the exchange-correlation functional. The strong correlation effect of transition metal is addressed with the Hubbard U correction to density functional theory (GGA+U). The reported Hubbard U values of 3.9 and 6.4 were applied for the 3d electrons of Mn and Ni atoms, respectively. A kinetic energy cutoff value of 520 eV was used to sample the Brillouin zone using Gamma-centered k-point meshes with a constant density (KSPACING=0.2), which has been confirmed to converge total energy within 1 meV/atom. For structural relaxations and self-consistent calculations, the convergence thresholds for total energy and force are 10⁻⁵ eV and 10⁻² eV/Å, respectively.

### Example 1

### Synthesis of Capped Honeycomb LMR (CH-LMR)

The Mn_{0.75}Ni_{0.25}CO₃ microspherical precursors were obtained by a co-precipitation method. An aqueous solution (2 mol L⁻¹) of NiSO₄·6H₂O and MnSO₄·H₂O with the molar ratio of Ni:Mn=1:3, and an aqueous solution of NH₃·H₂O (0.5 mol L⁻¹) and Na₂CO₃ (2 mol L⁻¹) were separately pumped into a continuously stirred tank reactor (CSTR, 2 L) under N₂ atmosphere at 50° C. to maintain the pH=8.4±0.2. After filtering, several times washing with H₂O and drying in a vacuum oven at 90° C., the microspherical precursors were obtained. Then, the as-prepared precursors (1.05 g) were mixed uniformly with Al₂O₃, Na₂CO₃ and Li₂CO₃. Finally, the mixture was calcined in air at 780° C. for 10 h, quenched to room temperature to obtain a black intermediate product (i.e. P2-Na_{0.6}Li_{0.2}Mn₃ₓNiₓO₂), and then subjected to ion exchange in molten LiNO₃/LiCl at 300° C. for 4 h to form a lumpy residue. To obtain the target product, the residue was washed, filtered, and dried overnight at 180° C., named as CH-LMR, which has a chemical formula of Li_{1.1}(Ni_{0.21}Mn_{0.65}Al_{0.04})O₂.

The design of CH-LMR cathode without voltage decay focused on stabilizing the honeycomb structure of LMR by local atomistic modification to create a TM (transition metal)-pinned honeycomb LMR (also referred as capped honeycomb LMR, CH-LMR). The LMR with 02-stacking lattice was selected as a matrix material, which was synthesized via a P2-O2 ion-exchange method of the P2-type Na/Li-TMO₂ precursor (i.e. P2-Na_{0.6}Li_{0.2}Mn₃ₓNiₓO₂) at low temperature (as compared with typical calcinating temperature in conventional Li-rich material synthesis that usually exceeds 700° C.). In particular, the capped honeycomb local structure is built by introducing an optimal “overdose” of TM-carbonates (i.e., Mn_{0.75}Ni_{0.25}CO₃ microspherical precursor), in excess of about 13% stoichiometric amount, into the P2-Na_{0.6}Li_{0.2}Mn₃ₓNiₓO₂ with Al-doping. In this P2 precursor, the ratio of TM ions (Mn and Ni) is about 3:1 and any excess TM ions with respect to the P2-type precursor would be thermodynamically disfavored from occupying the Na sites due to the unaccommodating prismatic coordination. That said, the P2-type precursor may be regarded as a P2-type “Na-poor” layered compound i.e., Na_{0.56}Li_{0.18}Ni_{0.2}Mn_{0.6}O₂, based on the ICP results, with more prismatic vacancies.

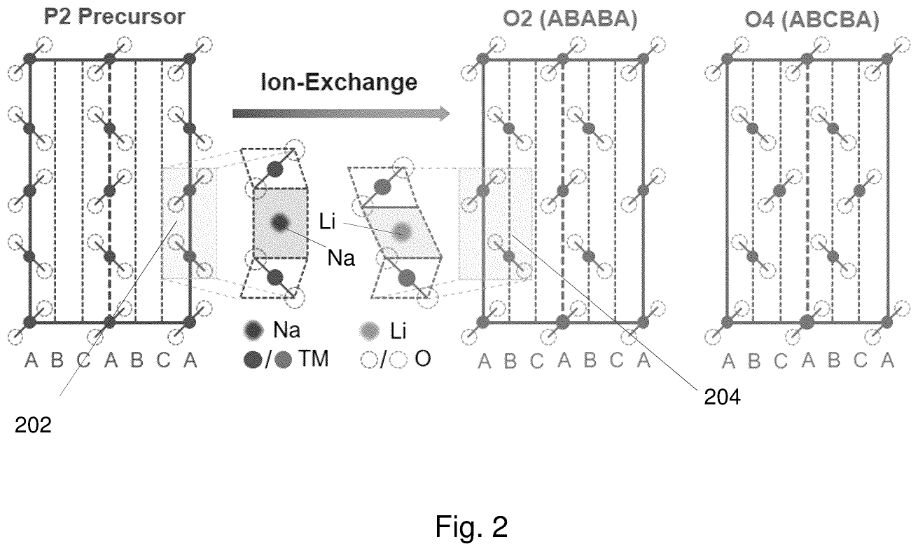

During the subsequent ion exchange process, the alkali coordination between layers transforms from prism (P2) to octahedron (O2). The latter is suitable for accommodating TM ions and therefore facilitates TM migration to the alkali octahedra (FIG. 2). Accordingly, once the ion exchange occurs, the excessive quantity of TMs is inclined to occupy the alkali sites, competing with guest Li⁺ and finally reaching a unique O2 framework with TMs partially occupying the Li sites (i.e., TM_{Li} ions as discussed in the later part of the present disclosure).

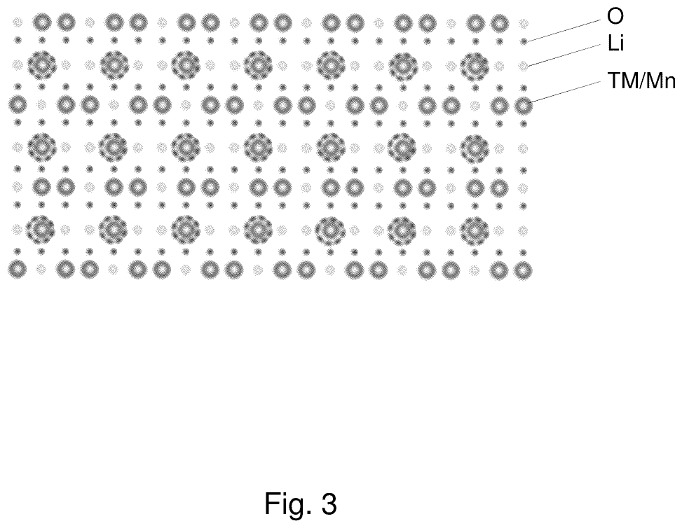

In addition, for 02-type LMRs, each interlayer octahedron is sandwiched between one face-shared octahedron on the one side and two edge-shared octahedra on the other side (see FIG. 3). During the ion exchange process, the edge-shared octahedra intrinsically provide a possible pathway for TM migration through the neighboring tetrahedron, which facilitates the TM_{Li} occupancy. On the other side, the face-shared octahedron bonds the TM_{Li} with three oxygen ions, which means the LiO₆ honeycomb could be directly pinned by TM_{Li} ions. This unique local structural configuration enables the O2-stacked lattice to be an ideal matrix. By contrast, it is believed that conventional O3-type LMRs show only edge-shared octahedra on both sides of interlayer LiO₆. As a result, the O3-type honeycomb structure cannot be pinned analogously, even if some TM_{Li} ions may be accommodated in the interlayer octahedra.

### Example 2

### Structural Characterization of CH-LMR

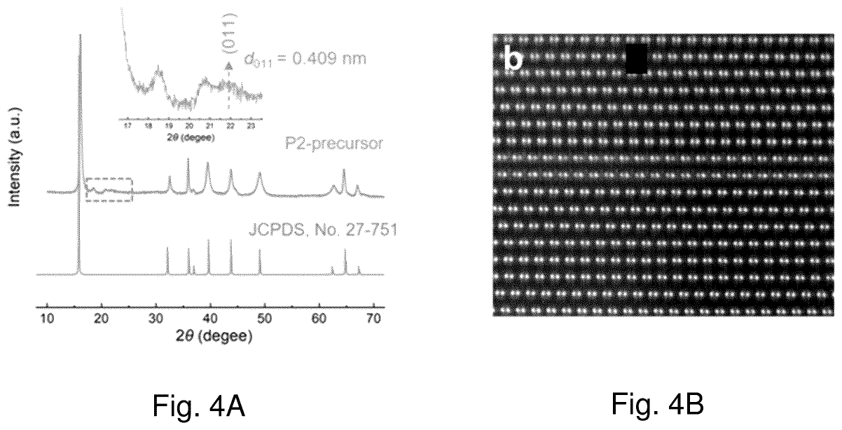

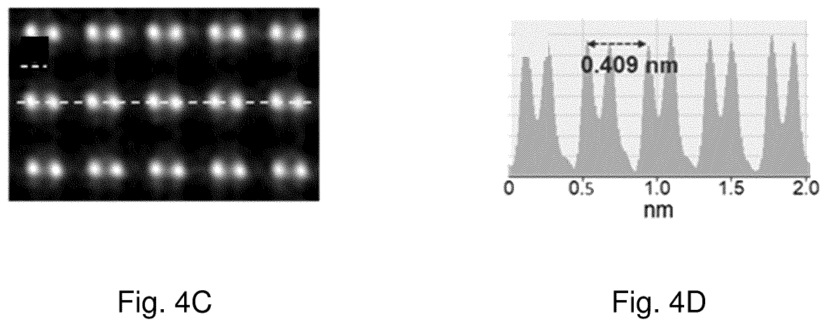

The structure of the Na-based layered precursor, Na_{0.6}Li_{0.2}Mn₃ₓNiₓO₂ with Al-doping, before ion exchange is first investigated. As shown in FIG. 4A, its X-ray diffraction (XRD) pattern can be indexed with a P2-type layered structure (JCPDS No. 27-751). The additional weak reflections at a 2θ angle around 18°-23° are fingerprints of the typical Li/TM ordering in TMO₂ slabs (FIG. 4A. insert). The scanning transmission electron microscopy high-angle annular dark-field (STEM-HAADF) image shows “dumbbell”-like pairs along the [110] projection (FIG. 4B). The periodicity of the Li/TM ordering is ˜0.409 nm (FIGS. 4C and 4D), consistent with the (011) peak in the XRD pattern.

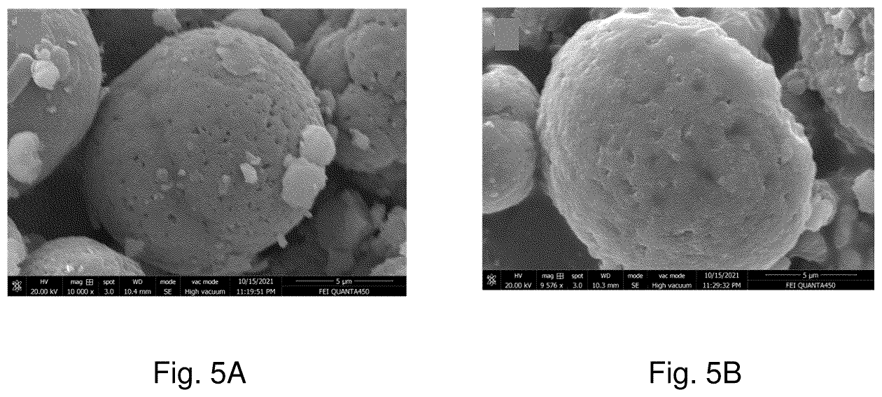

After ion exchanged, the as-obtained CHLMR has a chemical composition of Li_{1.1}(Ni_{0.21}Mn_{0.65}Al_{0.04})O₂ with negligible residual Na as determined by inductively coupled plasma (ICP) spectroscopy. SEM images (FIG. 5A) suggest illustrate that the as-prepared CH-LMR has a spherical morphology agglomerated compactly with primary grains, which is generally resemble to the P2 precursor (FIG. 5B).

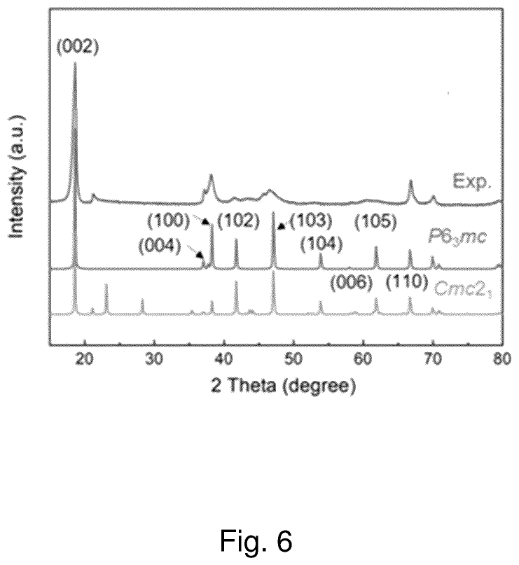

The XRD pattern of the ion-exchanged CH-LMR is shown in FIG. 6. Based on the calculated diffraction patterns, the material has a composite structure consisting of layered hexagonal (P6₃mc) LiTMO₂ and orthorhombic (Cmc2₁) Li₂MnO₃ (i.e., Li[Li_{1/3}Mn_{2/3}]O₂) components, both of which show an O2 stacking lattice (see FIG. 1A). The XRD patterns of these two structures share most of the Bragg positions, except for the additional weak peaks of [Li_{1/3}Mn_{2/3}]n ordering in the orthorhombic phase. Notably, the experimental diffraction peaks of (00l) and (hk0) are sharp. This indicates a good structural coherence along the c-axis as well as in the ab-plane. On the other hand, all other (hkl)-mixed peaks, such as (012), (013) and (014), are broad. This indicates that stacking faults exist within the O2 slabs, which could be due to spontaneous slab gliding during the P2-O2 ion-exchange process.

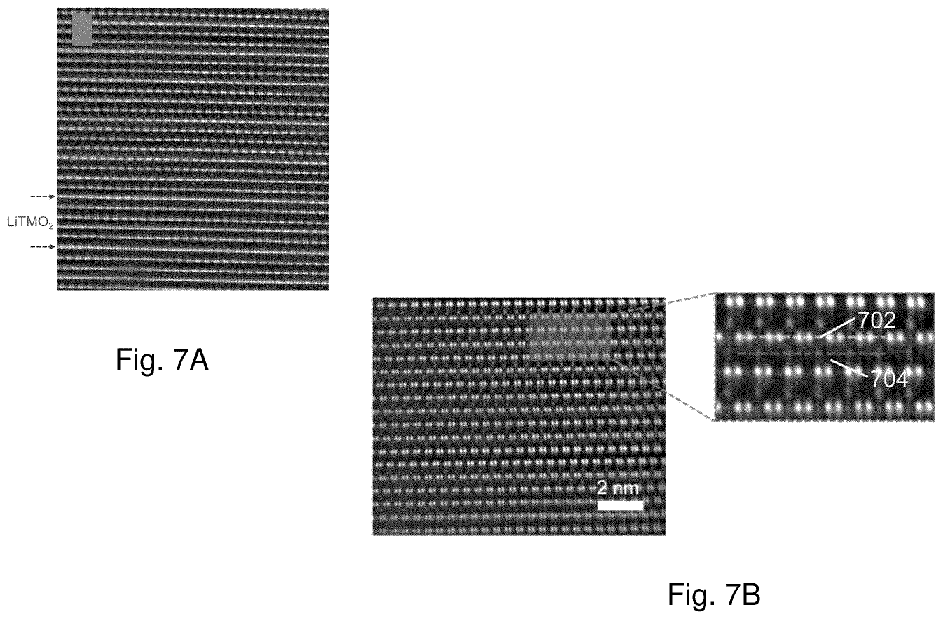

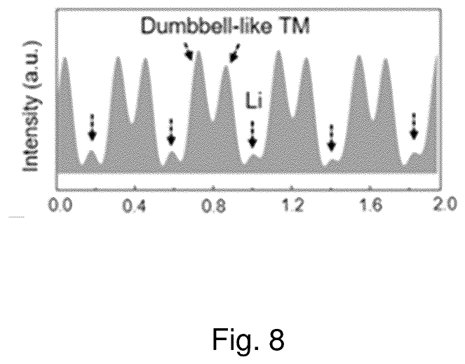

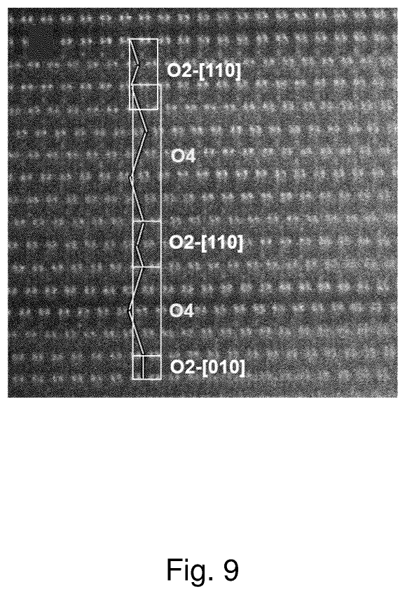

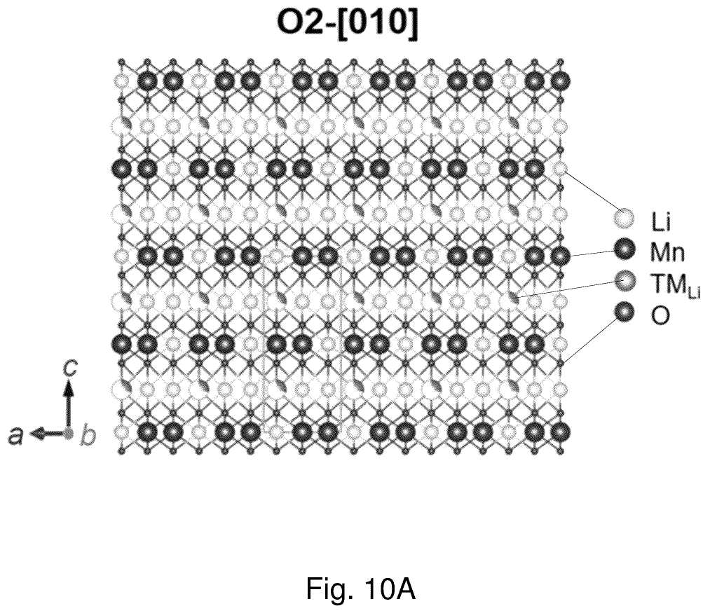

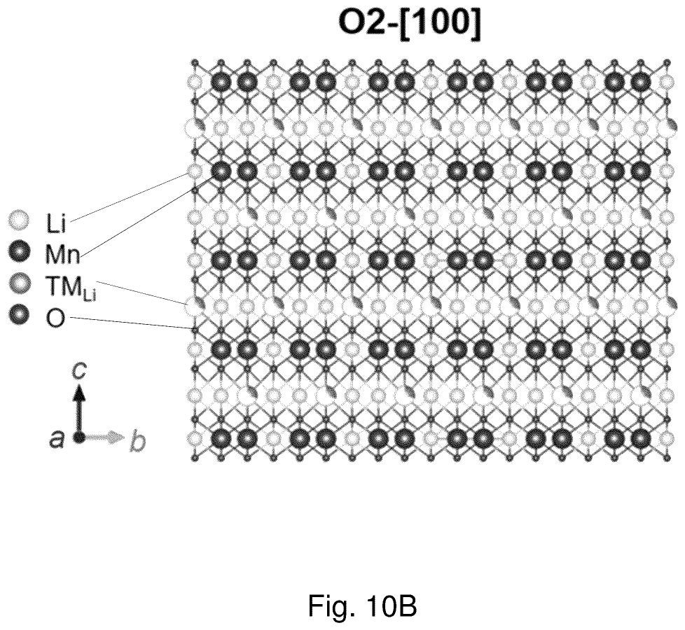

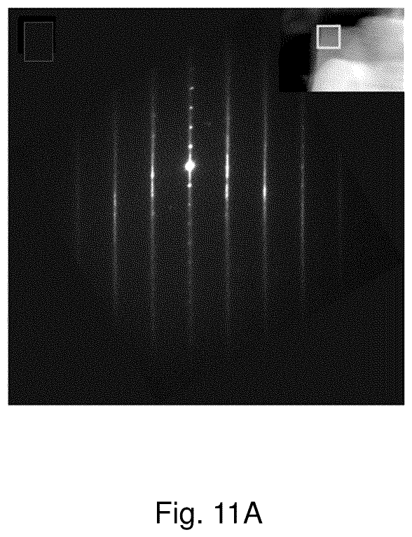

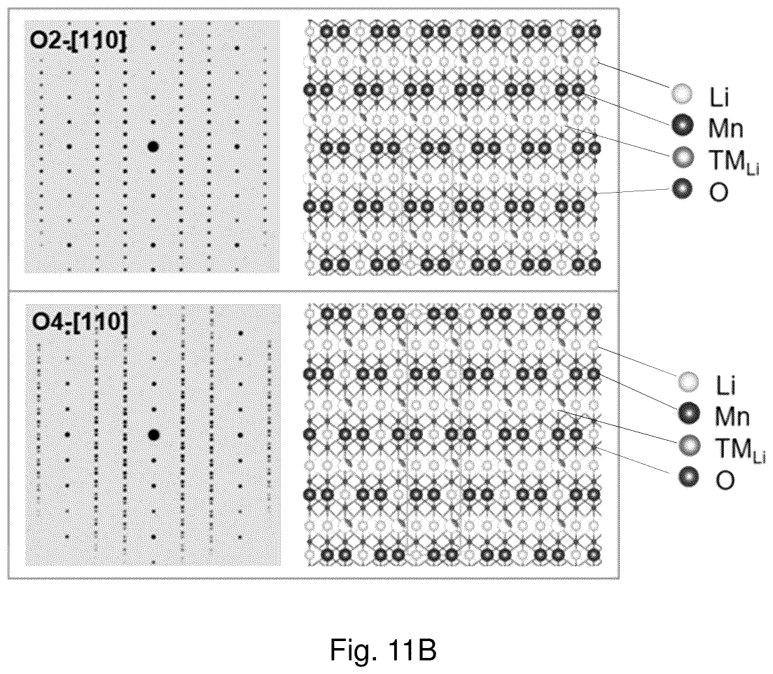

A large area STEM-HADDF image of the CH-LMR shows a composite structure with layered LiTMO₂ and orthorhombic Li₂MnO₃ components (FIG. 7A). FIG. 7B shows the enlarged STEM-HADDF images of the dumbbell-like superstructure in the Li₂MnO₃ phase and the corresponding schematic diagram of the atomic arrangement is shown in FIG. 3. The periodicity of 0.409 nm (FIG. 8) is the characteristic feature of the honeycomb structure. Based on the locations of the [Li_{1/3}Mn_{2/3}] units, the stacking sequences of the MnO₂ slabs could be identified mostly as O2-(ABAB) and O4-(ABCB) types (FIG. 9). Note that the O4-type stack could revert to the O2 type by moving the third MnO₂ layer. There are other stacks in the STEM image, which can be assigned to the [010]-viewed O2 arrangement (i.e., a 600 rotation with respect to the [110]) (FIGS. 10A and 10B). The diffraction spots of (h0l) are joined into a continuous line in the selected area's electron diffraction patterns (SAED, FIGS. 11A and 11B), which clearly shows the richness of the stacking sequence in this material.

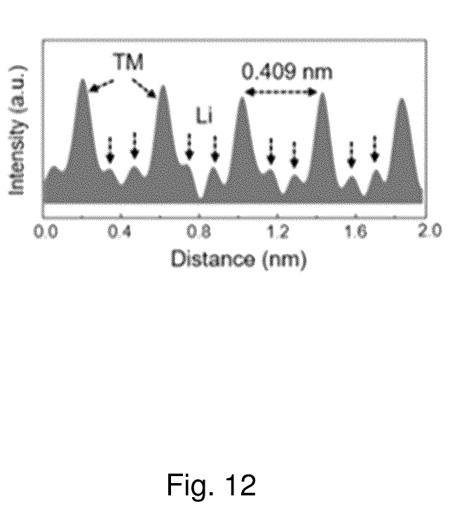

Particularly, in the Li₂MnO₃ phase, the STEM image exhibits ordered spots in the Li layers, indicating that some TMs are partially occupying some of the interlayer Li sites (referred as TM_{Li} ions). As viewed from the [110] projection, the horizontal distance between two TM_{Li} ions in the Li slabs is ˜0.409 nm (FIG. 12), equivalent to an ordered substitution of one TM for every three Li ions, and the periodicity of this repeating unit [Li_{2/3}Mn_{1/3}] is the same as that of [Li_{1/3}Mn_{2/3}] in the TM layers.

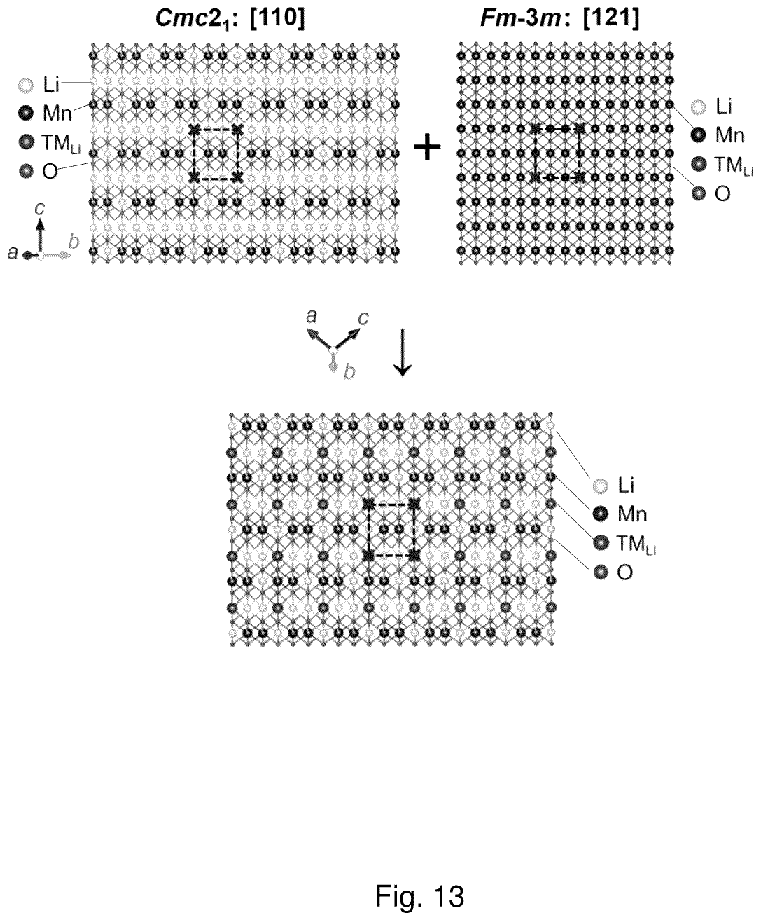

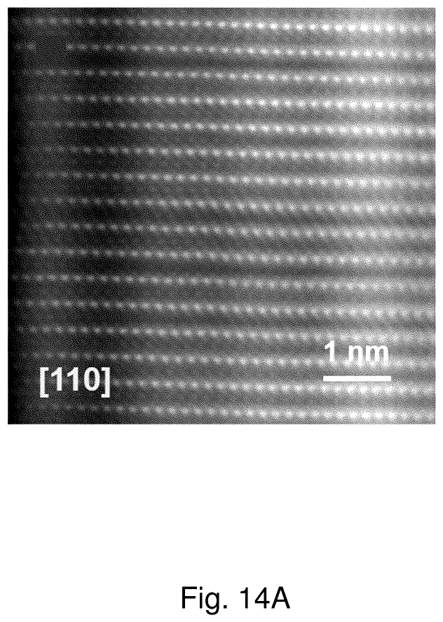

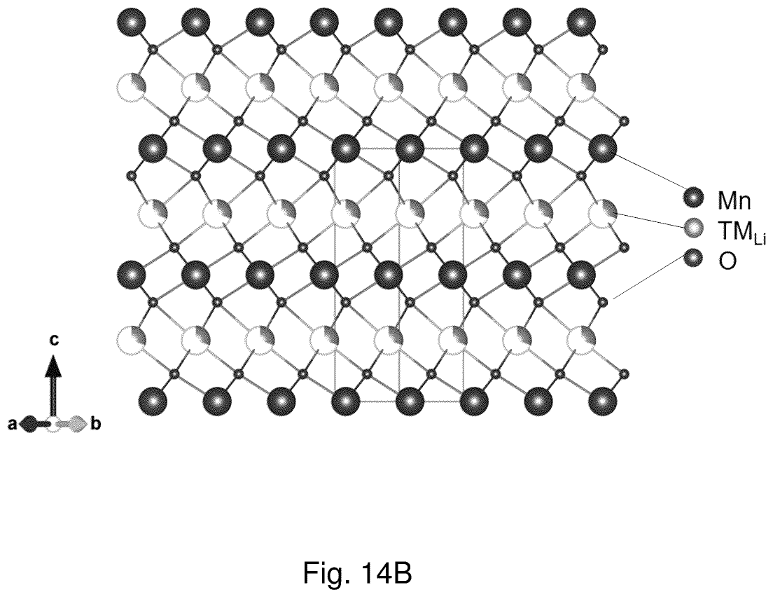

In order to understand the features observed, a structural model is built to describe this special atomic arrangement (FIG. 3). The O2-Li₂MnO₃ lattice and rectangular TM_{Li} are compatibly combined by sharing identical closely packed O-sublattices in a face-centered pseudo-cubic scheme. Intuitively, this combination could be regarded as an interwoven mixture of [110]-axial O2-Li₂MnO₃ and [121]-axial cubic Fm-3 m structure with a different Li/TM occupancies (FIG. 13). This structural model also matches the STEM atomic pattern viewed from the [110] zone axis (FIGS. 14A and 14B).

A close inspection of the TM_{Li} location in the STEM images and the constructed models reveals that they occupy specific sites in the Li layers, namely those right above or below the Li ions in the LiMn₆ honeycomb structure (FIGS. 1B and 1C). Each TM_{Li} ion bonds three oxygen atoms from the Li octahedron inside the LiMn₆ honeycomb, which means the TM_{Li}O₆ and the honeycomb LiO₆ octahedra share faces. In other words, the unstable LiO₆ honeycombs are pinned by the TM_{Li} in CH-LMR.

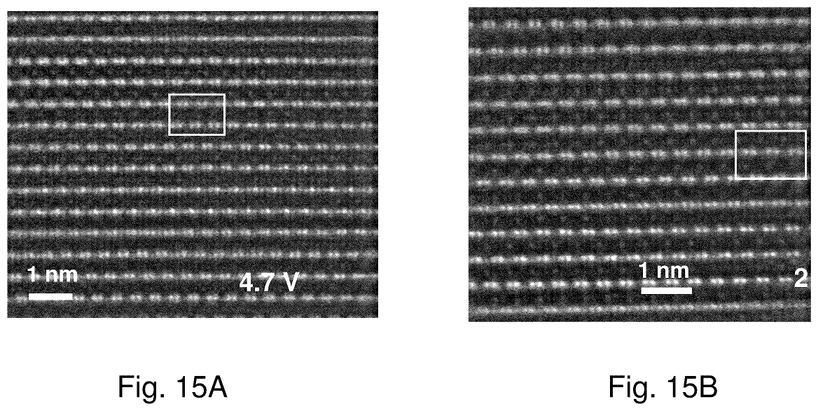

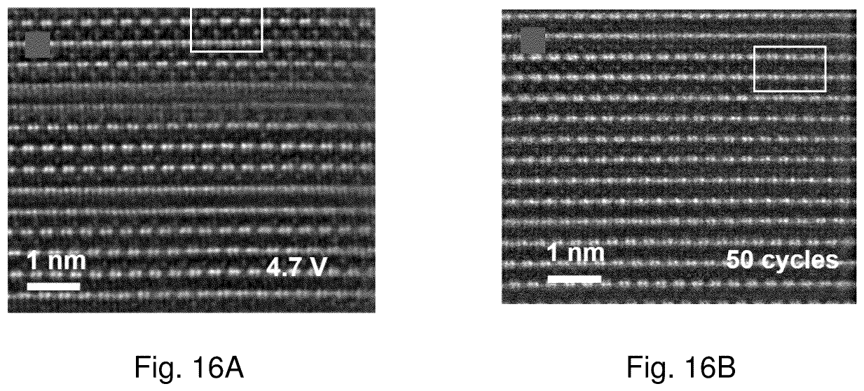

From the local structure viewpoint, this special block of TM_{Li}-honeycomb could benefit the electrochemical performance in two ways. First, irreversible cation migration, which is recognized as a leading cause of voltage decay in Li-rich cathodes, is believed to be inhibited by the TM_{Li} occupancy. Whilst it is reported that O2-stacked material might enable reversible cation migration, it is believed that progressive structural damage would occur in the reported O2-type cathodes upon charge-discharge cycling, particularly at a high voltage, rendering the voltage stability of the reported cathodes far from satisfactory. In contrast, as shown in the STEM images, the TM_{Li} sublattice remains intact at high voltage (4.7 V) after 2 cycles (FIGS. 15A and 15B) and even after 50 cycles (FIGS. 16A and 16B), indicating the persistent inhibition of the cation migration of the CH-LMR.

Second, irreversible oxygen redox would cause oxygen release and performance degradation in reported Li-rich cathode materials. In particular, the 0 atoms next to the Li atoms in the honeycomb structure are unstable at high voltages and tend to de-coordinate from the lattice, leading to irreversible O2 release and rapid performance decay in the reported Li-rich cathodes. In contrast, the TM_{Li} of CH-LMR could pin the unstable honeycomb O²⁻ by localizing the O₂ₚ lone-pair state (which will be discussed in the DFT section below, Example 3), thereby increasing the formation energy of oxygen vacancy and stabilizing oxygen.

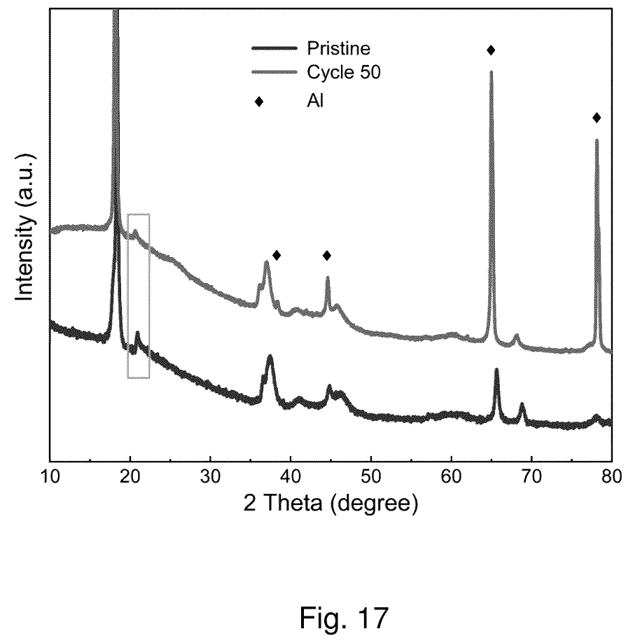

In sum, the honeycomb structure in the CH-LMR material is stabilized upon cycling, which is also demonstrated by the well-maintained superstructure reflections in the XRD pattern of cycled material (FIG. 17). Thus, it is believed that the TM_{Li}-pinned honeycomb would enhance the cycling stability of the LIBs. The electrochemical performance of the CH-LMR cathode will be discussed in Example 5.

### Example 3

### First-Principles Calculations

First-principles calculations are perform to understand the chemical/physical origins of the unique role of the interlayer TM_{Li} ions in stabilizing the honeycomb structure and preventing irreversible oxygen release at high voltage.

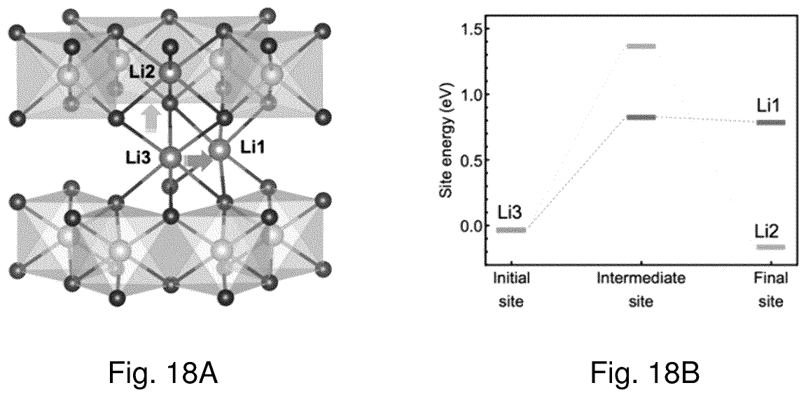

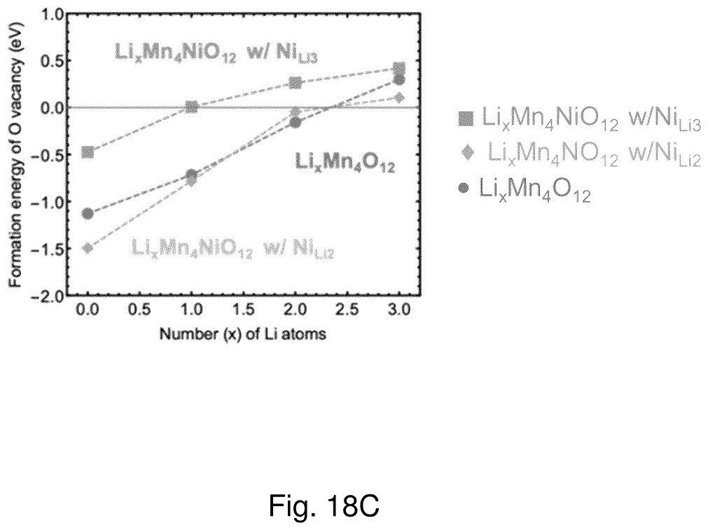

First, the thermodynamic stability of the TM-pinned honeycomb structure at high voltage is investigated. A simplified model consisting of four formula units of O2-MnO₃ with full delithiation is built and the energetics are examined when one TM ion (specifically assumed to be Ni) occupies various symmetrically distinct Li sites (denoted as TM_{Li1}, TM_{Li2}, and TM_{Li3}, respectively), i.e., O2-Mn₄NiO₁₂, as shown in FIG. 18A. The TM_{Li3} configuration corresponds to the experimentally observed residence of TM ion in the Li layers of O2-Li₂MnO₃ at the position just below the Li atom in the honeycomb structure, i.e., the TM-pinned honeycomb structure. The resulting relative energies in FIG. 18B reveal that Li2 and Li3 sites are energetically preferred, with a relatively small difference of 0.13 eV, while the Li1 site has significantly higher energy (0.86 eV compared to the Li3 site). The corresponding migration barriers in FIG. 18B indicate that although Li2 and Li3 sites are close in energy, the migration of the TM ion from the Li3 site to the Li2 requires overcoming an energy barrier as large as 1.4 eV. These results suggest that as long as the Li3 site is occupied by a TM ion, as observed in the synthesized sample, the TM_{Li3} configuration tends to be energetically stable without significant migration of TM ions even at high voltage, thus stabilizing the TM-pinned honeycomb structure.

Second, the possible mechanism of how the TM-pinned honeycomb structure promotes oxygen stability is examined. To explore this, the formation energy of oxygen vacancy is computed (considering the entropy of oxygen gas-phase under standard conditions) and its value in structures with (O2-LiₓMn₄NiO₁₂) and without (O2-LiₓMn₄O₁₂) a TM ion occupying the Li site is compared. Ni is chosen as the TM to occupy either the Li2 site (denoted as LiₓMn₄NiO₁₂ w/Ni_{Li2}) or the Li3 (denoted as LiₓMn₄NiO₁₂ w/Ni_{Li3}) site because of much lower energy compared to the Li1 site, as shown in FIG. 18B.

To reliably compute the formation energy of oxygen vacancy, the lowest energy configuration among all the possible arrangements of Li ions for each case of Li occupation (x=0, 1, 2, and 3) are determined, followed by finding the oxygen site that attains the lowest vacancy formation energy. As shown in FIG. 18C that the occupancy of Li3 site with TM ion in the Li layers of the O2-Li₂MnO₃ phase can notably suppress spontaneous oxygen gas release by increasing the formation energy of oxygen vacancy while displaying a decreasing effect with an increase in the number of Li atoms. This observation may seem connected to the fact that TM_{Li3} simply introduces more electrons and thus stabilizes oxygen, rather like adding more Li ions. However, it is found that TM_{Li2} seems not to help at all with the stabilization of oxygen compared with the case without TM, as clearly shown in FIG. 18C.

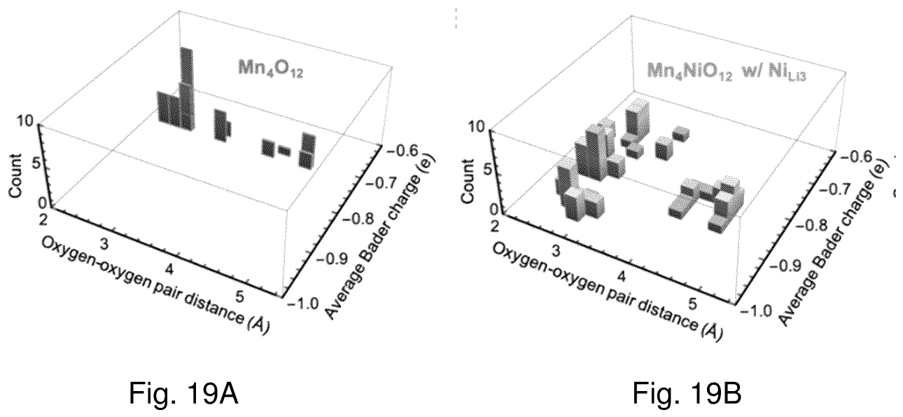

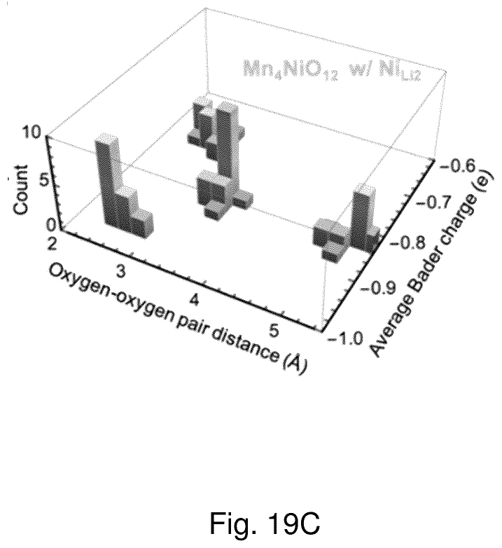

Since the formation of oxygen vacancy is closely related to charge transfer and dimerization, a statistical analysis of O—O pair distance and average Bader charge is performed. As shown in FIGS. 19A-19C, for the three fully delithiated cases, O2-Mn₄NiO₁₂ with Ni occupying either the Li3 or the Li2 site, and O2-Mn₄O₁₂, respectively, suggesting that oxygen atoms in O2-Mn₄O₁₂ without Ni show similar Bader charges of about −0.72|e| with varying O—O pair distances. In contrast, O2-Mn₄NiO₁₂ with additional Ni display overall significantly increased Bader charges ranging from −0.69|e| to −0.95|e|, as shown in FIGS. 19B and 19C. The intriguing point is that the distributions of the Bader charges on different oxygen atoms are rather different for the cases for Ni_{Li3} and Ni_{Li2}, with the former showing a more uniform distribution. It is also noticed that for both cases of Ni_{Li3} and Ni_{Li2} there is one O—O pair with a very low averaged Bader charge of −0.69|e|. But in the case of Ni_{Li2}, it shows a much shorter O—O pair distance (0.281 nm) than the case of Ni_{Li3} (0.339 nm). These results suggest Ni_{Li2} is probably not as effective as Ni_{Li3} in promoting the oxygen stability. Therefore, the calculations indicate that the TM-pinned honeycomb structure with TM occupying the Li3 site plays a unique role in stabilizing the oxygen.

In the interim, while emphasis is put on the positional configuration of TM for stabilizing the honeycomb structure, it is believed that the doped Al in CH-LMR might also play a role in stabilizing the honeycomb structure as well as suppressing voltage decay/fading, such as by way of forming bonding with oxygen atom within the honeycomb structure. The possible effect of the doped Al on the electrochemical performance of CH-LMR cathode will be discussed in Example 5.

### Example 4

### In situ Measurements

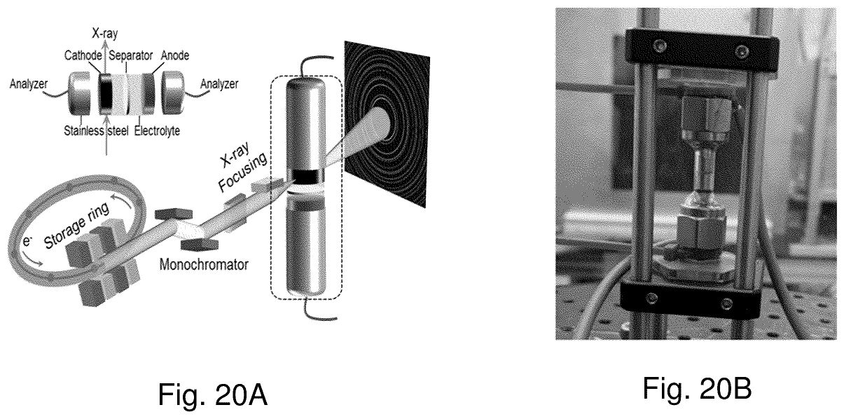

To study the structural evolution of the CH-LMR cathode, in situ synchrotron high-energy XRD measurements were performed during the first one and a half cycles using a custom-designed quartz-tube cell with a focused beam of 5×200 μm (vertical×horizontal). The focused beam enables only reflections of the sample to be observed. A scheme and a corresponding setup photograph are given in FIGS. 20A and 20B. Details of the setup are disclosed in the Characterization section.

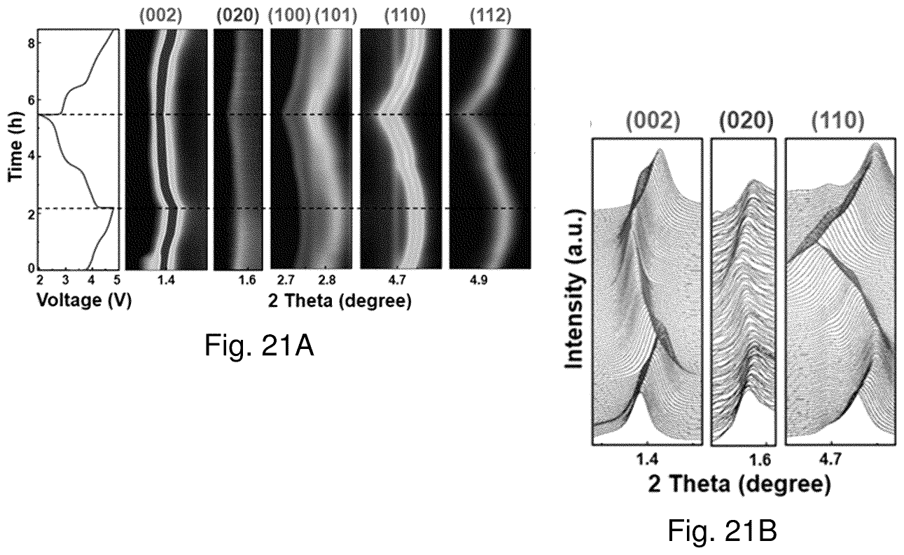

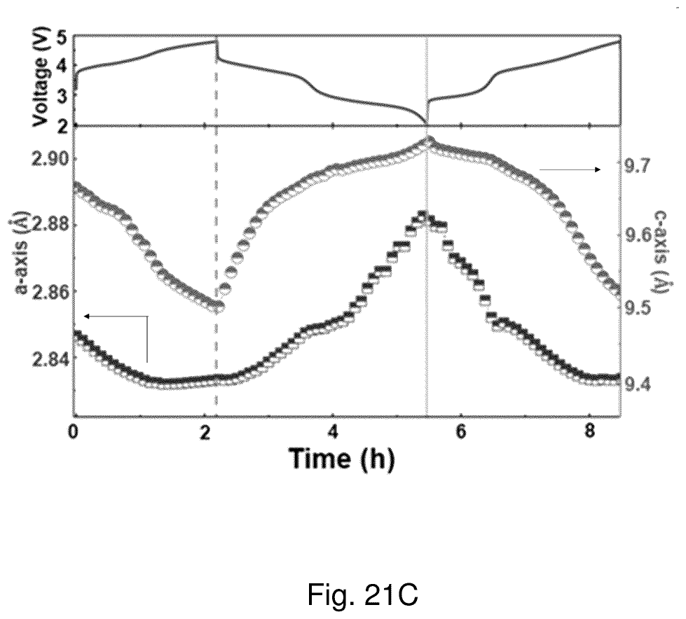

Contour plots of some characteristic XRD peaks are shown in FIG. 21A. Remarkably, the characteristic [020] feature of the [Li_{1/3}Mn_{2/3}]n superstructure in the Li₂MnO₃ component is well maintained well during the operation, as indicated by the stacked peak profiles in FIG. 21B. This result indicates that the honeycomb structure of the CH-LMR is stable in high-voltage cycling, which is consistent with the STEM and the ex situ XRD results.

The average lattice parameter changes obtained from the in situ XRD data are shown in FIG. 21C. During the initial charge up to ˜4.5 V, both the in-plane a-axis and interlayer c-axis decrease gradually. At high voltage, above 4.5 V, while the c axis continues to decrease, the a-axis stays nearly constant until the end of the charge. During the first discharge and the second charge, symmetrical and smooth evolutions are observed for both the a- and c-axes. These changes are distinctly different from most conventional Li-rich layered oxide materials, which are known to undergo irreversible lattice evolutions upon the first and the second cycle.

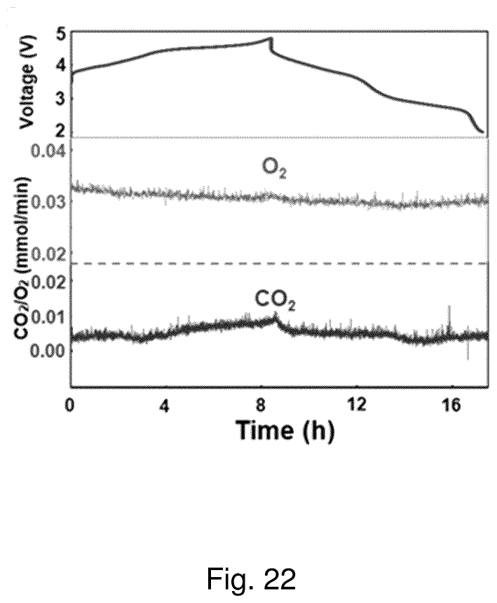

The reversible structural evolution in the CH-LMR material indicates that interlayer TM_{Li} ions can stabilize the honeycomb structure and are expected to prevent the irreversible O2 release at high voltage. To confirm this, in situ differential electrochemical mass spectrometry (DEMS) has been carried out and the result is shown in FIG. 22. When the charge voltage reaches 4.4 V, CO₂ gas begins to be detectable due to electrolyte decomposition. However, O2 was barely detectable, validating the suppression of the O2 release. Based on these in situ results, it is further confirmed that the honeycomb structure in the CH-LMR is stabilized during the electrochemical process, which is attributed to the pinning effect of the interlayer TM_{Li} ions.

### Example 5

### Electrochemical Performance of CH-LMR

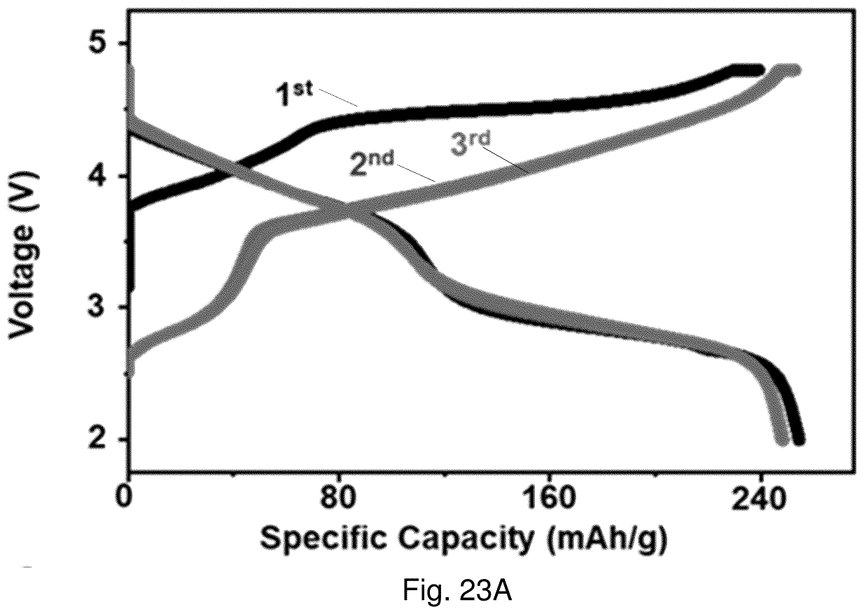

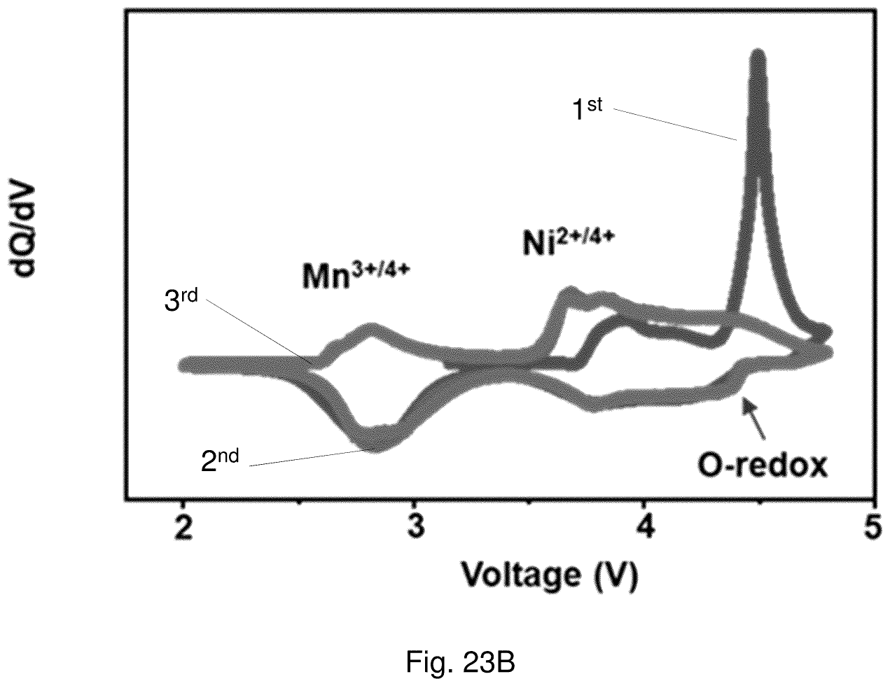

The electrochemical performance of the synthesized sample was evaluated at Argonne National Laboratory's benchmarking facility, Cell Analysis Modeling Prototype (CAMP). The first three charge-discharge curves of the CH-LMR in the voltage range of 2.0 V to 4.7 V at ˜0.1 C are shown in FIG. 23A, exhibiting an initial discharge capacity of 254.4 mAh/g with an energy density of 836 Wh/kg, which has increased by 20-30% compared to a commercial NCM622 cathode. The long high-voltage plateau during the initial charge is the characteristic feature of Li₂MnO₃ activation in LMR cathodes. Though the initial charge curves are different from the following charge processes, the discharge curves of the following three cycles are almost identical to that of the first one, with negligible capacity decay.

The results of dQ/dV plots during the formation cycles are shown in FIG. 23B, which can be used to investigate the redox mechanism. There is a high-intensity peak indicating the Li₂MnO₃ activation process. In subsequent cycles, the peak becomes a broad hump due to the partial overlap of cationic and anionic redox. As a result, the voltage boundary between the oxidation of nickel and oxygen disappears and becomes a long voltage ramp. The peak pairs at 3.5-4.4 V region belongs to the redox of Ni²⁺/Ni⁴⁺ in the layered LiTMO₂ phase, contributing to the initial capacity (<4.4 V).

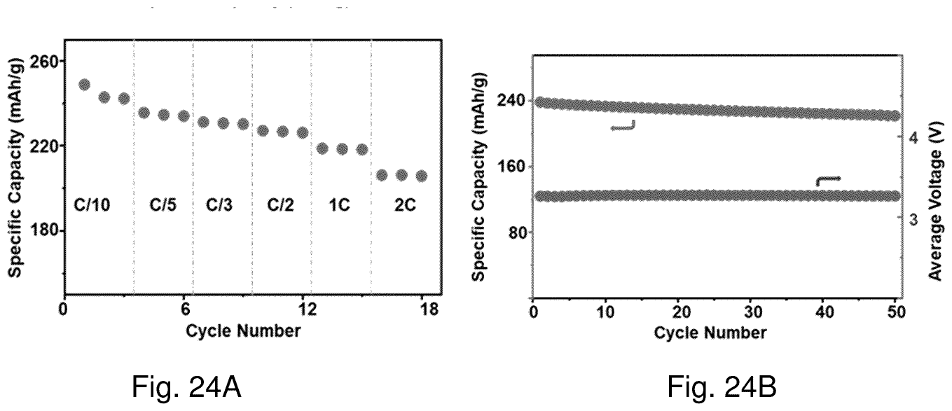

As shown in FIG. 24A, the synthesized CH-LMR exhibits a very good rate capability. Even at the high rate of 2C, the material still delivers a discharge capacity as large as 206 mAh/g. Notably, the synthesized CH-LMR cathode possesses an outstanding capacity and voltage stability (FIG. 24B). A specific discharge capacity of 248 mAh/g is achieved after the three formation cycles, and the capacity retention of the sample is 96% over 50 cycles at C/3, with a cut-off voltage of 4.7 V.

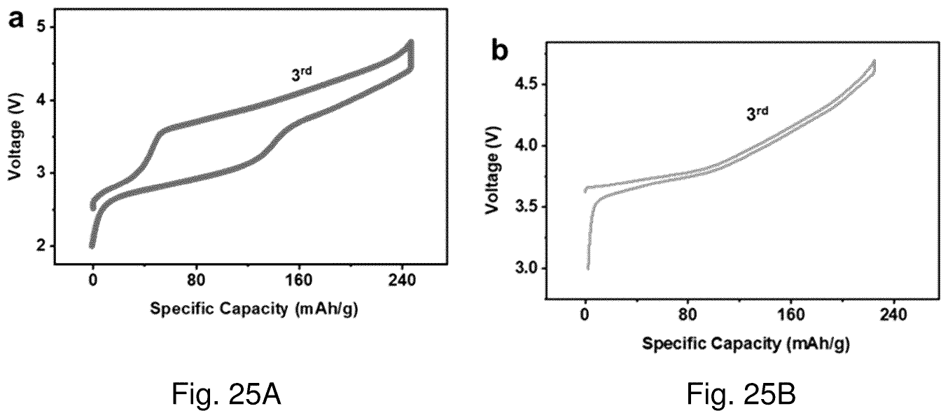

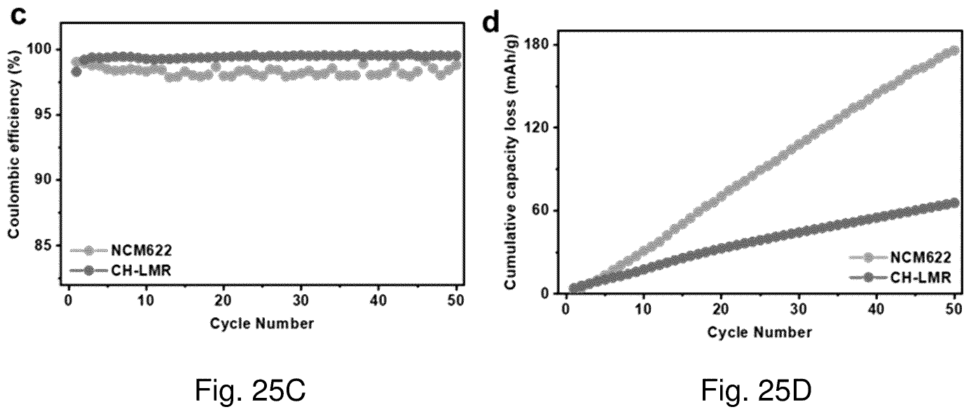

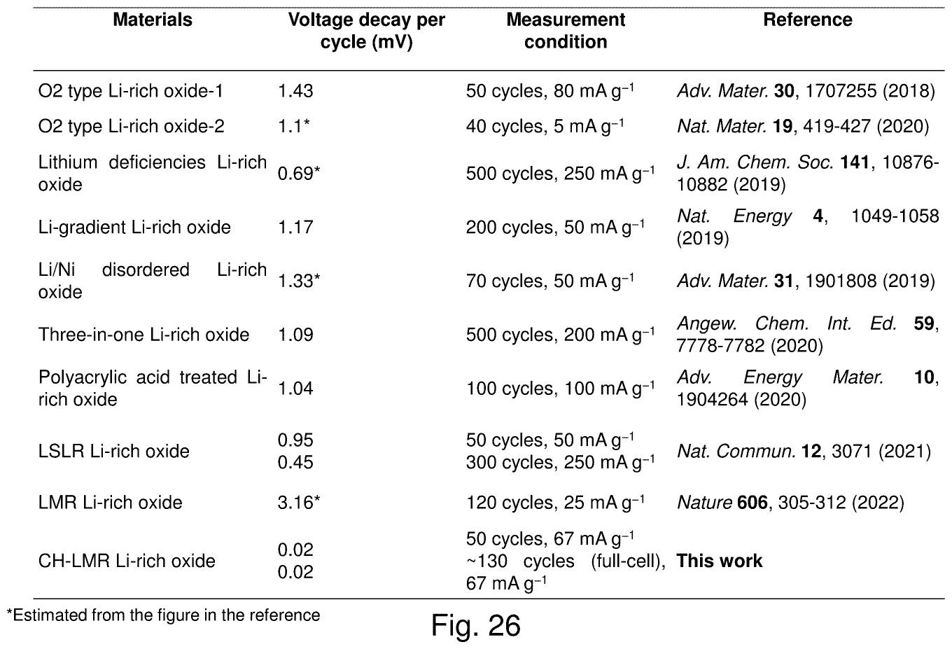

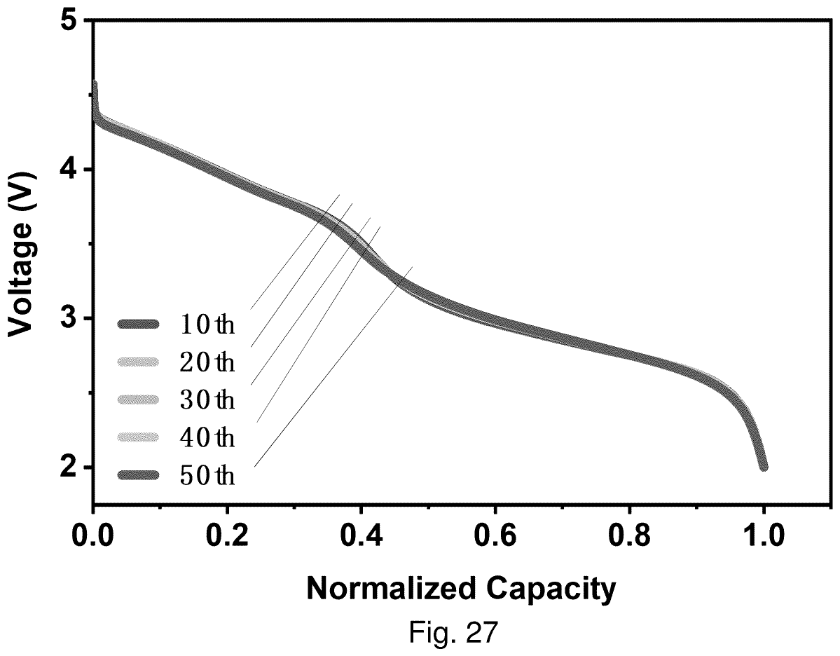

The third charge-discharge voltage profile shows a typical hysteresis for Li-rich layered oxide cathodes (FIG. 25A), in comparison with that of NCM622 (FIG. 25B). In addition, up to 4.7 V, a higher and stable Coulombic efficiency and as well as a small cumulative irreversible capacity loss can be observed for the CH-LMR cathode (FIGS. 25C and 25D), which demonstrate the stable structure and less side reactions of the CH-LMR. Most importantly, the CH-LMR voltage does not decay after cycling 50 times at C/3 (˜0.02 mV per cycle), while the typical voltage fading value for reported LMR cathodes is usually more than about 0.45 mV per cycle, and mostly about 1 mV per cycle (FIG. 26). Meanwhile, the normalized discharge curves for different cycles almost overlap (FIG. 27).

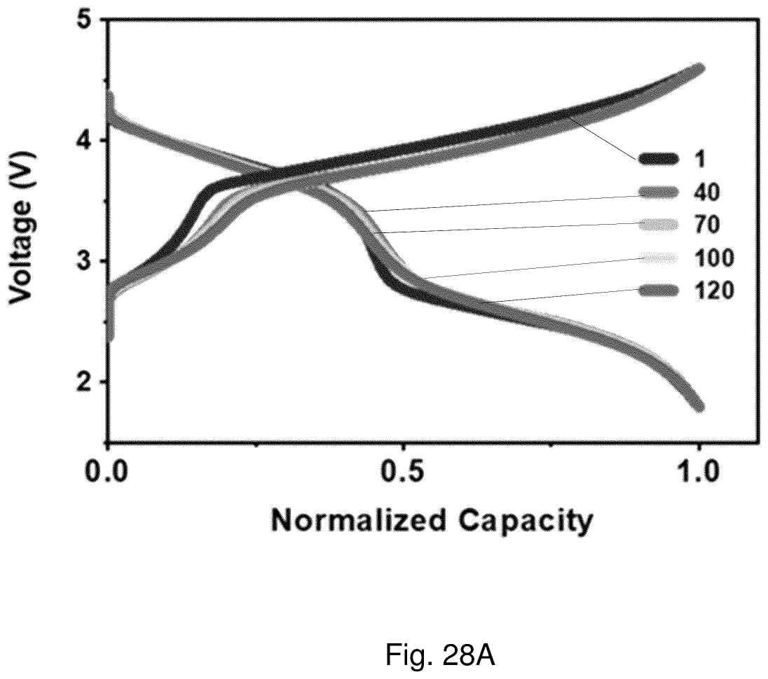

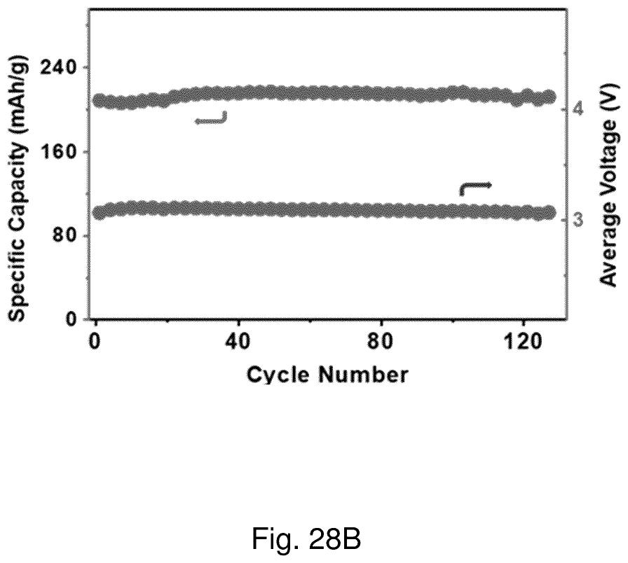

Similar electrochemical experiments are carried out on the CH-LMR material with a full cell setting, which uses graphite as the anode. As shown in FIGS. 28A and 28B, it is further confirmed that the voltage decay is as small as ˜0.02 mV/per cycle.

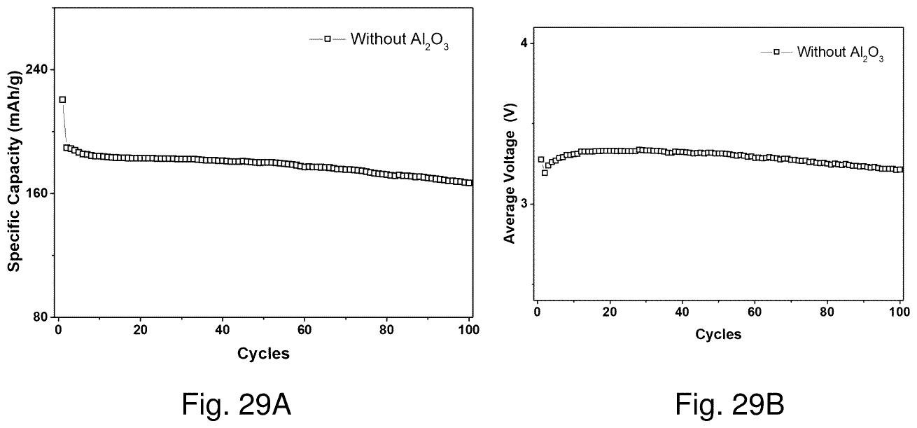

Furthermore, as mentioned above, the doped Al might have certain effect on the electrochemical performance of the CH-LMR. Indeed, as shown in FIGS. 29A and 29B, the cathode without Al₂O₃ added during the synthesis (i.e., without Al doping) showed a poorer capacity retention of 87.8% and a larger voltage drop of 0.12 V for 100 cycles (as compared with FIGS. 24B and 28B), suggesting the doped Al may have a role in the stabilization of the honeycomb structure such as suppressing the irreversible oxygen loss. Nonetheless, it should be emphasized that the suppression of voltage decay of CH-LMR is mainly attributed to the positional configuration of TM as discussed herein.

The invention has been given by way of example only, and various other modifications of and/or alterations to the described embodiment may be made by persons skilled in the art without departing from the scope of the invention as specified in the appended claims.

1. A method for preparing an electrode material comprising the steps of:
a) producing a microspherical precursor by way of co-precipitation;
b) forming an intermediate product by calcining the precursor with a stoichiometric amount of sodium carbonate, lithium carbonate and a structural stabilizer; and
c) performing an ion exchange process to the intermediate product under molten LiNO₃/LiCl to form a lumpy residue.

2. The method as claimed in claim 1, wherein step a) comprises the steps of:
providing a first aqueous solution comprising at least two transition metal sulfates selected from sulfates of nickel, iron, manganese, titanium, zirconium, vanadium, or chromium;
providing a second aqueous solution comprising one or more of a precipitating agent selected from a group consisting of ammonium hydroxide, sodium carbonate, sodium bicarbonate, sodium hydroxide, and potassium hydroxide; and
mixing the first and the second aqueous solutions to form a first reaction mixture for co-precipitation.

3. The method as claimed in claim 2, wherein the first aqueous solution comprises NiSO₄·6H₂O and MnSO₄·H₂O with a molar ratio of Ni:Mn≈1:3.

4. The method as claimed in claim 2, wherein the second aqueous solution comprises NH₃·H₂O and Na₂CO₃.

5. The method as claimed in claim 2, wherein the first reaction mixture has a pH of about 8 to about 9.

6. The method as claimed in claim 1, wherein the structural stabilizer comprises Al₂O₃.

7. The method as claimed in claim 6, wherein the sodium carbonate, lithium carbonate, and Al₂O₃ have a molar ratio of about 12:4:1 with respect to Na:Li:Al and are mixed with the precursor to form a second reaction mixture.

8. The method as claimed in claim 1, wherein the calcining process is performed at about 780° C. for about 8 hours to about 10 hours.

9. The method as claimed in claim 1, wherein the ion exchange process is performed at about 300° C. for about 4 hours.

10. The method as claimed in claim 2, wherein the first and second aqueous solutions are pumped simultaneously into a continuously stirred tank reactor under N₂ atmosphere at a temperature of about 50° C.

11. The method as claimed in claim 2, wherein the first aqueous solution has a concentration in a range of about 1.5-3 mol/L.

12. The method as claimed in claim 11, wherein concentration ratio between the transition metal sulfates and the precipitating agent is in a range of about 1-2.

13. An electrode for lithium-ion battery comprising an electrode material having a general formula of Li[Li_{1/3}(TMₓAl_{y})]O₂, wherein TM is a transition metal selected from one or more of nickel, iron, manganese, titanium, zirconium, vanadium, chromium, and x+y=⅔; and the electrode material comprises a dual phase layered structure.

14. The electrode as claimed in claim 13, wherein the dual phase layered structure comprises a heterogeneous structure of LiTMO₂ domain and Li₂MnO₃ domain, with TM being a transition metal selected from one or more of nickel, iron, manganese, titanium, zirconium, vanadium, chromium.

15. The electrode as claimed in claim 14, wherein both the LiTMO₂ domain and Li₂MnO₃ domain are arranged in a form of an O2-type stacking lattice.

16. The electrode as claimed in claim 15, wherein the LiTMO₂ domain is arranged as a hexagonal lattice.

17. The electrode as claimed in claim 16, wherein the hexagonal lattice has a space group of P6₃mc.

18. The electrode as claimed in claim 15, wherein the Li₂MnO₃ domain is arranged as an orthorhombic lattice.

19. The electrode as claimed in claim 18, wherein the orthorhombic lattice has a space group of Cmc2₁.

20. The electrode as claimed in claim 18, wherein the Li₂MnO₃ domain has a honeycomb LiMn₆ ordering structure.

21. The electrode as claimed in claim 14, wherein at least a portion of TM partially occupies the interlayer Li site of the Li₂MnO₃ domain.

22. The electrode as claimed in claim 21, wherein every three Li sites is substituted by one TM.

23. The electrode as claimed in claim 22, wherein each of the TM bonds to three oxygen atoms from the LiO₆ octahedron of the honeycomb structure, thereby stabilizing the honeycomb structure.

24. The electrode as claimed in claim 22, wherein each of the TM is located at a position just above or below the Li atom of the LiO₆ octahedron.

25. The electrode as claimed in claim 20, wherein Al acts as a dopant which further stabilizes the honeycomb structure by forming bonding with oxygen atom within the honeycomb structure.

26. The electrode as claimed in claim 13, wherein the electrode material has a spherical morphology agglomerated compactly with primary grains.

27. The electrode as claimed in claim 26, wherein the electrode material comprises Li_{1.1}(Ni_{0.21}Mn_{0.65}Al_{0.04})O₂.

28. The electrode as claimed in claim 13 comprising a cathode.

29. A lithium-ion battery comprising an electrode as claimed in claim 13, wherein the electrode is a cathode.

30. The lithium-ion battery as claimed in claim 29 comprising a half coin cell, wherein the cathode comprises an electrode material having Li_{1.1}(Ni_{0.21}Mn_{0.65}Al_{0.04})O₂.

31. The lithium-ion battery as claimed in claim 30, wherein the cathode is electrically connected to an anode comprises lithium metal.

32. The lithium-ion battery as claimed in claim 29 comprising a full coin cell wherein the cathode comprises an electrode material having Li_{1.1}(Ni_{0.21}Mn_{0.65}Al_{0.04})O₂.

33. The lithium-ion battery as claimed in claim 32, wherein the cathode is electrically connected to an anode comprises activated graphite.

34. The lithium-ion battery as claimed in claim 29, wherein the average voltage of the battery remains substantially unchanged for at least 50 charge-discharge cycles at C/3.

35. The lithium-ion battery as claimed in claim 34, wherein the average voltage decays constantly by about 0.02 mV per cycle.
